(19) United States
(12) Patent Application Publication
(10) Pub. No.: US 2026/0045821 A1
(43) Pub. Date: Feb. 12, 2026

(54) FAST CHARGING SYSTEM AND METHOD FOR LITHIUM-ION BATTERIES

(71) Applicant: University of North Dakota, Grand Forks, ND (US)

(72) Inventors: Shabaz Khan, Portage, MI (US); Xiaodong Hou, Grand Forks, ND (US); Rahate Ahmed, Grand Forks, ND (US)

(21) Appl. No.: 19/056,328

(22) Filed: Feb. 18, 2025

Related U.S. Application Data
(60) Provisional application No. 63/554,646, filed on Feb. 16, 2024.

(51) Int. Cl. H02J 7/00; H01M 10/0525; H01M 10/44

(52) U.S. Cl. CPC H02J 7/007192; H01M 10/0525; H01M 10/443; H02J 7/0047; H02J 7/00711

(57) ABSTRACT

A method of performing fast-charging for a lithium-ion battery (LIB) includes sensing an environmental temperature, performing an initial constant-current charging and subsequent discharge of the LIB, and evaluating whether the sensed environmental temperature falls below a threshold temperature. If the sensed environmental temperature initially falls below a threshold temperature, the LIB is charged via a dynamic alternating current (AC) charging according to a low-temperature charging algorithm to heat and charge the lithium-ion battery. Once the LIB reaches a temperature below the threshold temperature, charging switches to a comparatively high-temperature charging algorithm.

### CROSS-REFERENCE TO RELATED APPLICATION(S)

This application claims the benefit of U.S. Provisional Application No. 63/554,646 filed Feb. 16, 2024 for “FAST CHARGING LITHIUM-ION BATTERIES” by S. Khan, X. Hou, D. Laudal, and M. Mann, which is herein incorporated by reference in its entirety.

### BACKGROUND

The present invention relates generally to battery technologies, and more particularly to a fast-charging approach for lithium-ion batteries (LIBs).

Efforts to improve LIB performance have primarily focused on two areas: 1) high-performing batteries and 2) energy-efficient electronics. High-performing batteries depend on two components: 1) the battery itself and 2) the battery charging method. Different charging methods have been invented to meet charging requirements and overcome limitations due to significant differences in electrochemical properties; however, fast-charging LIBs at temperatures below freezing remains a significant challenge. Existing charging technologies have been primarily developed for applications at room temperature.

The promise of electric vehicles (EVs) in addressing climate change and energy security issues has led automakers to flood the market with new EVs. However, range anxiety remains the biggest obstacle for the increasingly popular EV market. Consumers are concerned about recharging time and the availability of fast charging stations. Studies show that EV owners are more likely to travel to areas with fast charging capabilities, which account for over 25% of all regions. Temperature is a primary limiting factor for fast charging, as charging Li-ion cells at freezing temperatures is difficult and can result in increased polarization and reduced diffusivity in the anode. Maintaining battery quality without sacrificing other attributes is often challenging at freezing temperatures. Pre-heating methods have been attempted, but internal heating is more efficient and can distribute temperature more consistently, shortening the heat transfer path. In the US, where 47 states average 10 degrees Celsius in winter and 23 states stay below the average all year, EVs must be weather-independent and have faster charging capabilities to compete effectively in the market. However, low temperatures are unavoidable in practical use, although they are known to damage the battery. Therefore, charging protocols should adapt to the low-temperature environment to avoid possible capacity degradation. There is a recognized and unmet need for improved fast charging techniques for lithium-ion batteries, further complicated by special needs cand challenges associated with charging needs at freezing or below-freezing temperatures. With conventional charging approaches, both freezing temperature and High C-rates correlate inversely with battery cycling life.

In recent years several techniques have been developed for fast LIB charging, including constant voltage-constant current (CC-CV) charging, multi-stage constant current charging (MSCC), boost charging, and a variety of pulse charging (PC) approaches including variable-frequency pulse-charging system (VFPCS), duty-varied pulse-charge strategy (DFVPCS) and adaptive pulse charge system (APCS) approaches.

Using CC-CV charging, a constant current is provided to charge the battery until the battery voltage increase to a preset maximum charging voltage. The charging voltage is held constant at a pre-selected voltage level, and the charging current is condensed exponentially. Based on the charging current in a CC mode, the total charging time may stretch to 2+ hours. Increasing the current level for fast charging is essential, but high current can increase the terminal voltage. This difficulty can be overcome in multi-stage constant current charging (MSCC), allowing high charging current to be applied during charging. MSCC includes multiple, successive charging current stages. A pre-set current is initially used for charging. This charging current continues until a pre-set voltage level is reached. Then the charging current level changes and this change between current and voltage remains for four to five stages. This charging method begins with very high current, which decreases with every successive stage. MSCC interrupts the phase/rate of continuous accumulation of heat and help to prevent overheating. Boost charging was developed to pursue high demands for decreasing charging time. This charging technique can in some cases charge much more quickly (e.g., a third of a full discharge battery in 5 minutes), but also reduces the capacity of the cell. Where simple charging approaches might provide 300 battery cycles, for examples, conventional boost charging may only permit 100 to 150 cycles—a severe concern for many users.

Several charging methods designed to protect batteries from unwanted lithium plating and sudden capacity degradation have been developed and patented. US20210328449 A1 discloses a charging method using a charging control device to monitor all battery parameters and a charging boundary to apply the maximum charging current. US20160023563 A1 discloses systems and methods used to fast-charge batteries at low temperatures using a rechargeable battery, called an ‘all-climate battery,’ which is capable of self-heating using a Ni foil and can be used at sub-zero temperatures. See, e.g., Nature: Wang, Chao Yang, et al., 2016. “Lithium-Ion Battery Structure That Self-Heats at Low Temperatures.” Nature 529 (7587): 515-18 http://dx.doi.org/10.1038/nature 16502; Wang, Chao Yang, et al. 2022 “Fast Charging of Energy-Dense Lithium-Ion Batteries.” Nature (February); Wang, Chao-Yang et al. 2016. “A Fast Rechargeable Lithium-Ion Battery at Subfreezing Temperatures.” Journal of The Electrochemical Society 163 (9): A1944-50; and Zhang, Guangsheng, et al. 2016. “Rapid Self-Heating and Internal Temperature Sensing of Lithium-Ion Batteries at Low Temperatures.” Electrochimica Acta 218:149-55. http://dx.doi.org/10.1016/j.electacta.2016.09.117. See, also, “Systems and Methods for Fast Charging Batteries at Low Temperatures,” (US20160023563 A1) and “Ohmically Modulated Battery” (US20160268646 A1). Standard CC-CV charging technology allows charging of a battery to 70% within 11 minutes at room temperature and 80% within 15 minutes at temperatures below freezing. This approach allows fast-charging at temperatures below freezing, but is only well-suited for cold-temperature applications.

“Adaptive Battery Charging Based on Battery Condition” (US20020075003 A1) and “Battery Charger for Lithium-Based Batteries” (U.S. Pat. No. 6,366,056B1) disclose adapting charging rate according to battery deterioration level or capacity degradation level, as reported in Purushothaman, B. K., P. W. Morrison, and U. Landau. 2005. “Reducing Mass-Transport Limitations by Application of Special Pulsed Current Modes.” Journal of The Electrochemical Society 152(4): J33). Attempts have been made to use pulse charge and discharge based on different pulse voltages to overcome negative side effects, which are responsible for premature battery capacity degradation, as reported in Purushothaman, B. K., and U. Landau. 2006. “Rapid Charging of Lithium-Ion Batteries Using Pulsed Currents.” Journal of The Electrochemical Society 153(3): A533.

### SUMMARY

In one aspect, the present disclosure is directed toward a method of performing fast-charging for a lithium-ion battery (LIB). This method includes sensing an environmental temperature, performing an initial constant-current charging and subsequent discharge of the LIB, and evaluating whether the sensed environmental temperature falls below a threshold temperature. If the sensed environmental temperature initially falls below a threshold temperature, the LIB is charged via a dynamic alternating current (AC) charging according to a low-temperature charging algorithm to heat and charge the lithium-ion battery. Once the LIB reaches a temperature below the threshold temperature, charging switches to a comparatively high-temperature charging algorithm.

In another aspect, the present disclosure is directed to a charging system configured to perform the aforementioned method, and including a constant current source, a pulse width modulation (PWM) controller, a logic-capable processor, and a temperature sensor.

The present summary is provided only by way of example, and not limitation. Other aspects of the present disclosure will be appreciated in view of the entirety of the present disclosure, including the entire text, claims, and accompanying figures.

### BRIEF DESCRIPTION OF THE DRAWINGS

The patent or application file contains at least one drawing executed in color. Copies of this patent or patent application publication with the color drawing will be provided by the Office upon request and payment of the necessary fee.

FIG. 1 is a schematic block diagram of a charging system.

FIG. 2 is a method flowchart illustrating a decision fork in operation of the charging system of FIG. 1.

FIG. 3 is schematic method model illustrating battery charging and discharging stages for use with the method of FIG. 2.

FIGS. 4a-4d are graphs of incremental capacity (IC) curves representative of four different cutoff voltage and algorithm mode conditions.

FIGS. 5a-5d are Nyquist plots representative of the four different cutoff voltage and algorithm mode conditions of FIGS. 4a-4d.

FIGS. 6a-6d are Ohmic resistance bar graphs representative of the four different cutoff voltage and algorithm mode conditions of FIGS. 4a-4d.

FIG. 7a-7d are solid electrolyte interface (SEI) resistance bar graphs representative of the four different cutoff voltage and algorithm mode conditions of FIGS. 4a-4d.

FIG. 8a-8d are charge transfer resistance bar graphs representative of the four different cutoff voltage and algorithm mode conditions of FIGS. 4a-4d.

FIG. 9a-9d are capacity bar graphs representative of the four different cutoff voltage and algorithm mode conditions of FIGS. 4a-4d.

FIG. 10a is a graph of battery surface temperature change as a function of state of charge (SoC) for a 0° C. charging algorithm.

FIG. 10b is a graph of battery internal heat generation rate as a function of SoC for a 0° C. charging algorithm.

FIG. 10c is a graph of battery surface temperature change as a function of depth of discharge (DOD) for a 0° C. charging algorithm.

FIG. 10d is a graph of battery internal heat generation rate as a function of DOD for a 0° C. charging algorithm.

FIG. 11a is a graph of battery surface temperature change as a function of SoC for a 25° C. charging algorithm.

FIG. 11b is a graph of battery internal heat generation rate as a function of SoC for a 25° C. charging algorithm.

FIG. 11c is a graph of battery surface temperature change as a function of DOD for a 25° C. charging algorithm.

FIG. 11d is a graph of battery internal heat generation rate as a function of DOD for a 25° C. charging algorithm.

FIG. 12a is a graph of battery surface temperature change as a function of SoC fifteen minutes after beginning a 0° C. charging algorithm.

FIG. 12b is a graph of battery internal heat generation rate as a function of SoC fifteen minutes after beginning a 0° C. charging algorithm.

FIG. 12c is a graph of battery surface temperature change as a function of DOD fifteen minutes after beginning a 0° C. charging algorithm.

FIG. 12d is a graph of battery internal heat generation rate as a function of DOD fifteen minutes after beginning a 0° C. charging algorithm.

FIGS. 13a-d are bar graphs illustrating proportion of heat generation rate (reversible vs. irreversible) vs. SOC using a 0° C. charging algorithm for charging rates of 1C to 4C, respectively.

FIGS. 14a-d are bar graphs illustrating proportion of heat generation rate (reversible vs. irreversible) vs. SoC using a 25° C. charging algorithm for charging rates of 1C to 4C, respectively.

FIGS. 15a-d are bar graphs illustrating proportion of heat generation rate (reversible vs. irreversible) vs. SoC for charging rates of 1C to 4C, respectively, fifteen minutes after beginning a 0° C. charging algorithm.

FIGS. 16a-f are bar graphs illustrating heat generation rate as a function of SoC and DOD for a 0° C. charging algorithm, for a 25° C. charging algorithm, and fifteen minutes after beginning a 0° C. charging algorithm.

FIG. 17 is a schematic illustration of a battery model for Lithium-ion battery components.

FIGS. 18a-d are charging profiles for LiCoO₂/graphite cell at 298.15K respectively illustrating voltage vs time, voltage vs. capacity, negative electrode surface concentration difference vs. SoC, and volume-averaged cell temperature vs. time.

FIGS. 19a-d are charging profiles for LiCoO₂/graphite cell at 258.15K respectively illustrating voltage vs time, voltage vs. capacity, negative electrode surface concentration difference vs. SoC, and volume-averaged cell temperature vs. time.

FIGS. 20a and 10b are plots of charging time at 1C and 2.5C rates, respectively, of CCCV charging after 278.15K cell temperature has been reached.

While the above-identified figures set forth one or more embodiments of the present disclosure, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features and components not specifically shown in the drawings.

### DESCRIPTION

This disclosure presents means and methods for fast charging of lithium-ion batteries in temperatures below freezing. This fast-charging technique pre-heats the battery at temperatures below freezing using an algorithm presented in detail below, eliminating the need for an extra pre-heat thermal management system. This charging technique can overcome negative side effects of conventional fast-charging techniques, resulting in slower capacity degradation and an increased battery lifespan. The associated charging stages are flexible and easily modified, and can therefore be used for a wide range of applications. This approach is applicable to a wide range of temperatures, simplifying charger design implementation.

Existing methods for mitigating battery degradation caused by long-term use are well-known, but such methods are not both suitable for freezing temperatures, and fast enough to be classified as a fast-charging method, following the USABC rule. The U.S. Advanced Battery Consortium's (USABC) goal for advanced batteries is to increase the state of charge (SoC) by 80% within 15 minutes of charging time (J. P. Christopherson, Battery Test Manual for Electric Vehicles, 2015, https://doi. org/10.2172/1186745). The battery temperature also rises quickly during charging using existing methods, further deteriorating battery condition. By contrast, the disclosure presents approaches with several key advantages, including: (1) Operation at both room temperature and temperatures below freezing. (2) Battery pre-heating through the charging process. No extra heating systems or special battery fabrication is needed. (3) Battery temperature remains below 40 degrees Celsius during fast charging. This fast-charging process easily mitigates limitations related to sharp increases in temperature. (4) This approach includes one pre-heat stage and five pulse stages, allowing battery charging above 55% at temperatures below freezing and above 80% at room temperature. This technique has multiple stages that are flexible enough for modification based on application, allowing the addition of another pulse charging stage with a rest period to charge the battery above 95%. (5) This technique can prevent lithium plating, protecting the battery from unwanted capacity degradation at room temperature and temperatures below freezing.

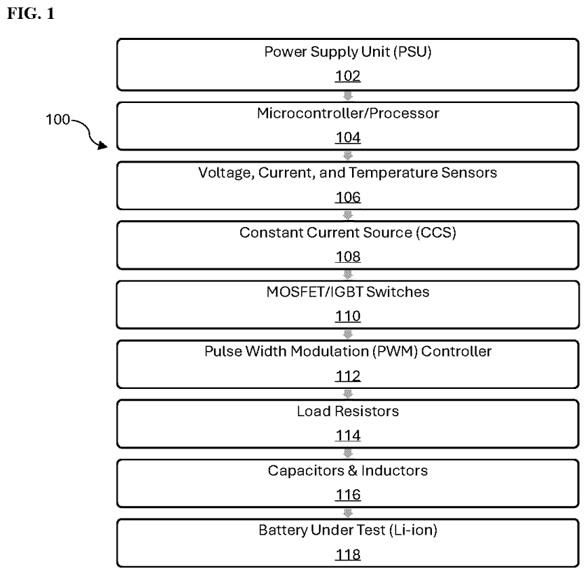

FIG. 1 provides a schematic block diagram of charging system 100 for testing of Lithium-ion battery (LIB) 118. As shown, charging system 100 includes power supply unit (PSU) 102, microcontroller/processor 104 (hereinafter processor 104), voltage, current, and temperature sensors 106, constant current source (CCS) 108, MOSFET/IGBT switches 110, pulse width modulation (PWM) controller 112, load resistors 114, capacitors and inductors 116, and LIB 118 itself. Charging system 100 is a system for rapidly charging LIP 118 in both freezing and above-freezing environments, as set forth below.

PSU 102 provides necessary voltage and current for charging, and in some embodiments also provides power for microcontroller/processor 104. Microcontroller/processor 104 controls the monitoring and switching of power during charging of LIB 118 according to algorithms set forth below. Processor 104 can, in some embodiments, execute software, applications, and/or programs stored in separate machine-readable memory (not separately shown). In other embodiments, processor 104 can be configured an algorithm purely by hardware arrangement. In some illustrative examples, processor 104 can include one or more of a processor, a microprocessor, a controller, a digital signal processor (DSP), an application specific integrated circuit (ASIC), a field-programmable gate array (FPGA), or other equivalent discrete or integrated logic circuitry. Processor 104 can be entirely or partially mounted on one or more circuit boards.

Sensors 106 include voltage and current sensors configured to continuously measure battery parameters for regulation, and provide inputs to processor 104 for charging algorithm control. Sensors 106 also include temperature sensors disposed to sense environmental temperature and, in some instances, temperature of LIB 118. CCS 108 ensures steady current during charging phases, while MOSFET/IGBT switches 110 enable switching between different charge/discharge modes as directed by processor 104. PWM controller 112 generates AC pulses for optimized charging as directed by processor 104, while load resistors 114 are used in discharge cycles to regulate current flow from LIB 118. Capacitors and inductors 116 are provided for smoothing of power delivery and pulse response.

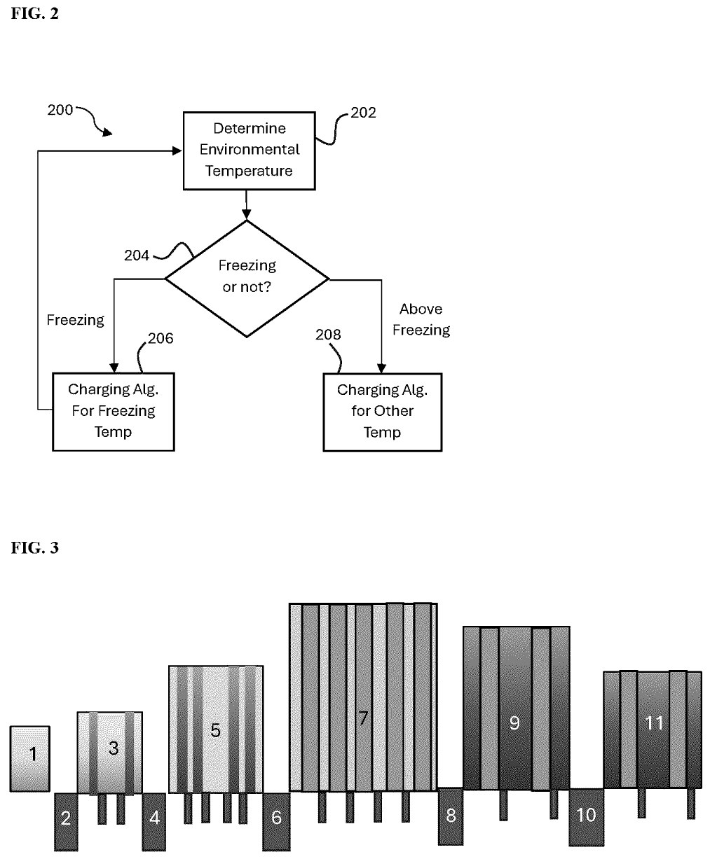

FIG. 2 is a method flowchart of a method 200, illustrating decision fork between freezing and above-freezing operation. Specifically, at system 100 is initialized at step 202 with processor 104 assessing environmental temperature as reported by sensors 106 to determine whether to execute charging algorithms tailored for below- or above-freezing operation. Although FIG. 2 mentions environmental temperature, battery temperature can in some examples be directly sensed instead or in addition to environmental temperature by sensors 106. If processor 204 determines (Step 204) that a relevant temperature is at or below freezing, processor 104 enacts a dynamic alternating current (AC) pulse algorithm for charging at freezing temperatures (Step 206). If temperatures are already above freezing, processor 104 instead enacts an alternative charging algorithm for room temperature or above-freezing temperatures. (Step 208). Both algorithms are described in greater detail below with reference to FIG. 3 and associated method step lists. In some instances system 100 can switch operational modes, e.g., from freezing to above-freezing algorithms once processor 104 determines from sensors 106 that a relevant temperature has risen above freezing. As principally described herein, method 200 proceeds to step 206 (hereinafter referred to as “0° C. charging”) if the sensed temperature is less than or equal to 0° C., and to step 208 if the sensed temperature is greater than 0° C. (hereinafter referred to as “25° C. charging”).

FIG. 3 is a method model schematically illustrating battery charging and discharging through one embodiment of stages 1-11. Stages 1 and 2 are identical for 0° C. charging and 25° C. charging, while stages 3-11 differ depending on the charging algorithm selected by processor 104 at step 204. Charging begins with one stage of constant current (CC) charging and discharge:

### Common Steps:

1. CC Charging:
   Apply 6.4 A CC for 2 minutes.
2. Discharge Pulse:
   Apply 9.6 A CC discharge for 1 second.

Subsequent charging follows different paths depending on the selected charging algorithm, as follows:

### 0° C. Charging Steps (for T≤0° C.):

3. First AC Pulse Section:
   Positive: 8 A, 1 s, 210 pulses.
   Negative: 1.6 A, 1 ms, 210 pulses.
4. Discharge Pulse: 9.6 A CC, 1 second.
5. Second AC Pulse Section:
   Positive: 6.4 A, 1 s, 180 pulses.
   Negative: 1.6 A, 1 ms, 180 pulses.
6. Discharge Pulse: 9.6 A CC, 1 second.
7. Third AC Pulse Section:
   Positive: 8 A, 1 s, 180 pulses.
   Negative: 1.6 A, 1 ms, 180 pulses.
8. Discharge Pulse: 9.6 A CC, 1 second.
9. Fourth AC Pulse Section:
   Positive: 8 A, 1 s, 150 pulses.
   Negative: 1.6 A, 1 ms, 150 pulses.
10. Discharge Pulse: 9.6 A CC, 1 second.
11. Fifth AC Pulse Section:
   Positive: 6.4 A, 1 s, 180 pulses.
   Negative: 1.6 A, 1 ms, 180 pulses.
      and: 25° C. charging steps (for T>0° C.):
3. First AC Pulse Section:
   Positive: 12.8 A, 1 s, 210 pulses.
   Negative: 1.6 A, 1 ms, 210 pulses.
4. Discharge Pulse: 9.6 A CC, 1 second.
5. Second AC Pulse Section:
   Positive: 9.6 A, 1 s, 180 pulses.
   Negative: 1.6 A, 1 ms, 180 pulses.
6. Discharge Pulse: 9.6 A CC, 1 second.
7. Third AC Pulse Section:
   Positive: 12.8 A, 1 s, 180 pulses.
   Negative: 1.6 A, 1 ms, 180 pulses.
8. Discharge Pulse: 9.6 A CC, 1 second.
9. Fourth AC Pulse Section:
   Positive: 12.8 A, 1 s, 150 pulses.
   Negative: 1.6 A, 1 ms, 150 pulses.
10. Discharge Pulse: 9.6 A CC, 1 second.
11. Fifth AC Pulse Section:
   Positive: 9.6 A, 1 s, 180 pulses.

After these steps are complete, method 200 either terminates (i.e., where LIB 118 is sufficiently charged) or switches modes (e.g., where battery temperature has sufficiently increased from 0° C. charging to enable 25° C. charging, instead. Positive charging pulses according to the 25° C. algorithm are, in the example case, at least 50% greater in current amplitude than corresponding positive charging pulses according to the 0° C. algorithm. In some examples, 0° C. and 25° C. charging algorithms may differ only in positive charging current amplitudes.

Fast-charging lithium iron phosphate (LFP) batteries at temperatures below freezing using convention methods is challenging and sometimes impossible. By contrast, the fast-charging technique disclosed herein can readily charge above 55% within 15 minutes at temperatures below freezing and above 80% within 15 minutes using the same charging stage at different C-rates. This fast-charging technique is weather independent, working both at room temperature and temperatures below freezing. Additionally, this fast-charging technique can pre-heat the battery internally, lowering material costs. This technology can also be used with current commercial lithium-iron-phosphate (LFP) batteries, making this system more cost-effective than existing technologies.

The greatest challenge with fast charging is overheating at room temperature. The technique disclosed herein mitigates this issue since the charging temperature stays under 40 degrees Celsius. Furthermore, this technique is flexibly modifiable for different battery-powered devices.

### Experimental Analyses

Results of experimental investigation, testing, and simulation are presented herein in support of the technological improvements introduced above. Illustrative studies and associated results are provided herewith in Lithium-ion Battery Fast Charging Technology at Freezing Temperature, The Impact of Temperature and Charging Rate on the Heat Generation of the LFP Battery, and Optimization of pulse charging algorithm to attain fast charging of lithium ion batteries in subzero temperature.

### Lithium-Ion Battery Fast Charging Technology at Freezing Temperatures

Conventionally, lead acid batteries have often been charged using pulse charging (PC) techniques. PC approaches optimized for LIB use have added a predefined rest interval or discharging period during the charging procedure to reduce or eradicate polarization effects in batteries. Charge efficiency can be improved by PC method, increasing battery cycle life and reducing charging time. Two well-known PC approaches use current pulses and voltage pulses, respectively. According to such approaches, a pulsed current is implemented by charging the battery cell using a charging protocol defined in advance, while a voltage pulse system implied by directing the duty cycle or frequency of applied current.

Variable-Frequency Pulse-Charge System (VFPCS), Duty-Varied Voltage Pulse-Charge Strategy (DFVPCS) and an Adaptive Pulse Charge System (APCS) are pulse charging techniques that operate based on optimized frequency, voltage or duty cycle. Adaptive charging systems can increase charging speeds. Positive Pulsed Current (PPC) and Negative Pulse Current (NPC) are the two main pulsed current technique which worked based on frequency, duty cycle, relaxation time, number of positive/negative pulse and magnitude. Some pulse current charging techniques derived from CC charging methods have also been developed. Experimental results reflect changing the CC charge in different amplitudes without providing any rest time, i.e., via pulse current with constant current (PC-CC). This charging technique is used as a prevention method of stress evaluation and properly utilizes battery capacity, while in some cases also reducing charging time. Pulse Width Modulation (PWM) mode and Pulse Amplitude Modulation (PAM) mode are two different ways to design a PM charging techniques. Under the operation of PWM mode, the current amplitude pulses remain constant, while the pulse width work as a variable. PAM is the reverse. Battery capacity degradation can be reduced and charging speed improved by controlling the charging process according to conditions of the battery. Prior research has attempted to adapt the PC-CC method for constant current-pulse charging (CC-PC), but without promising results. Notably, such methods begin with boost charging, which harms the health of the battery. Prior trials have also attempted to apply CV at the end of standard PPC method—an approach known as pulse current constant voltage (PC-CV) charging. Related research found that CV can help to improve battery health if used for a short period, while an extra CV stage can follow the end of a PC stage. As in PPC techniques, Negative Pulse Current (NPC) techniques have used a positive pulse and negative pulse one after another, followed by a resting period before starting the positive pulse. Short discharge steps can help increase battery cycle life and proper utilization of active material during the charging/discharging cycle period. Like PC-CC, this method uses an alternating current pulse (ACP), which is a continuous process of charge and discharge. This method helps to increase battery temperature for its alternating behavior and can be useful in cold temperatures. Negative Pulse current constant voltage (NPC-CV) method is a standard NPC method with CV steps. This other known multistage methods with negative pulses aim to reduce the capacity degradation during the cycle.

Some studies have looked into various methods of charging batteries at low temperatures, which can be categorized as external heating and internal heating. External heating has some disadvantages, including uneven heating and low energy efficiency. Therefore, researchers have started exploring internal heating methods such as internal self-healing, internal resistance heating, convection heating, pulse heating, and alternating current (AC) excitation heating. Self-heating methods involve preheating the battery by charging and discharging it to raise the temperature at low temperature. However, these approaches consume more energy and can accelerate battery aging. Proposed MPH methods for battery preheating consume less energy than internal heating methods, but can also accelerate battery aging and make system structure more complex.

A charging technique is tested (with results as described below) with the objectives of: 1) charging a battery to 90% within 15 minutes at 25 degree Celsius and more than 50% charge within 15 minutes at freezing temperature; 2) avoiding reductions to battery cycle life; and 3) providing a technique that can work via the same number of charging stages for both freezing and 25Celsius temperatures. Such a method reduces the complexity of charger design. This charging technique internally pre-heats the battery before fast charging to lower heat loss without sacrificing cycle life while maximizing the benefits.

### Methodology

Commercially available lithium LFP-based cells were used to study the unique fast charging technique at a freezing temperature of 0° C. and at ambient temperature of 25° C. The cells have a rated capacity of 3.2 Ah between 2V and 3.65 V. Two cells were used each temperature for two different condition. The conditions are 1) lower cut-off voltage 2.5V and 2) Lower cut-off voltage 3V. All experiments were performed inside a thermal chamber (Model: ESPEC), with the cells electrically loaded using a Neware cell cycle. The Neware unit enables the measurement of the cell voltage and current in max 5V and 30 A. In addition, thermocouples were attached to each cell to measure the cell surface temperature.

Processes with steps as set forth below were separately tested:
1.1.Fast Charging Technique (0° C.):
   1. 6.4 A CC charge for 2 min
   2. 9.6 A CC discharge for 1 s
   3. First alternating direct current Pulse section: Positive pulse at 8 A, where the pulse width is set to be 1 sec and the number of negative pulses for first section is 210 pulses. Negative pulse at 1.6 A, where the pulse width is set to be 1 mili-sec and the number of negative pulses for first section is 210 pulses.
   4. 9.6 A CC discharge for 1 s
   5. Second alternating direct current Pulse section: Positive pulse at 6.4 A, where the pulse width is set to be 1 sec and the number of negative pulses for first section is 180 pulses. Negative pulse at 1.6 A, where the pulse width is set to be 1 mili-sec and the number of negative pulses for first section is 180 pulses.
   6. 9.6 A CC discharge for 1 s
   7. Third alternating direct current Pulse section: Positive pulse at 8 A, where the pulse width is set to be 1 sec and the number of negative pulses for first section is 180 pulses. Negative pulse at 1.6 A, where the pulse width is set to be 1 mili-sec and the number of negative pulses for first section is 180 pulses.
   8. 9.6 A CC discharge for 1 s
   9. Forth alternating direct current Pulse section: Positive pulse at 8 A, where the pulse width is set to be 1 sec and the number of negative pulses for first section is 150 pulses. Negative pulse at 1.6 A, where the pulse width is set to be 1 mili-sec and the number of negative pulses for first section is 150 pulses.
   10. 9.6 A CC discharge for 1 s
   11. Fifth alternating direct current Pulse section: Positive pulse at 6.4 A, where the pulse width is set to be 1 sec and the number of negative pulses for first section is 180 pulses. Negative pulse at 1.6 A, where the pulse width is set to be 1 mili-sec and the number of negative pulses for first section is 180 pulses.
1.2.Fast Charging Technique (25° C.):
   1. 6.4 A CC charge for 2 min
   2. 9.6 A CC discharge for 1 s
   3. First alternating direct current Pulse section: Positive pulse at 12.8 A, where the pulse width is set to be 1 sec and the number of negative pulses for first section is 210 pulses. Negative pulse at 1.6 A, where the pulse width is set to be 1 mili-sec and the number of negative pulses for first section is 210 pulses.
   4. 9.6 A CC discharge for 1 s
   5. Second alternating direct current Pulse section: Positive pulse at 9.6 A, where the pulse width is set to be 1 sec and the number of negative pulses for first section is 180 pulses. Negative pulse at 1.6 A, where the pulse width is set to be 1 mili-sec and the number of negative pulses for first section is 180 pulses.
   6. 9.6 A CC discharge for 1 s
   7. Third alternating direct current Pulse section: Positive pulse at 12.8 A, where the pulse width is set to be 1 sec and the number of negative pulses for first section is 180 pulses. Negative pulse at 1.6 A, where the pulse width is set to be 1 mili-sec and the number of negative pulses for first section is 180 pulses.
   8. 9.6 A CC discharge for 1 s
   9. Forth alternating direct current Pulse section: Positive pulse at 12.8 A, where the pulse width is set to be 1 sec and the number of negative pulses for first section is 150 pulses. Negative pulse at 1.6 A, where the pulse width is set to be 1 mili-sec and the number of negative pulses for first section is 150 pulses.
   10. 9.6 A CC discharge for 1 s
   11. Fifth alternating direct current Pulse section: Positive pulse at 9.6 A, where the pulse width is set to be 1 sec and the number of negative pulses for first section is 180 pulses. Negative pulse at 1.6 A, where the pulse width is set to be 1 mili-sec and the number of negative pulses for first section is 180 pulses.

The condition for all pulse charging staged stop was cell upper maximum cut-off voltage. After application of fast charging techniques for different 2.5V and 3V lower cut-off voltage, the battery rests for 2 hours. After resting 2 hours, 0.5C rate CC discharge applies till 2.5V and 3V lower cut-off voltage. After discharging, the cell is kept at rest for 2 hours, after which EIS data is collected. After every 25 cycle of charge and discharge, EIS data is collected collect until 100 cycles have been completed. After every 25 cycles, a reference test is performed to evaluate capacity degradation. For reference testing at 0.5C, the battery is charged until voltage rises to the upper cut-off voltage of 3.65V, whereupon the CV charge stage begins. This CV stage lasts until the current reach of 0.01C. The battery is discharged at 0.3C to lower cut-off voltage by 2.5V. This testing procedure remains constant for both 0° C. and 25° C. testing (see above).

### Results and Discussion

The main goals of this battery fast charging method are to achieve a 90% charge in 15 minutes at 25° C. and to charge over 50% in 15 minutes at 20° C. Our goal was to optimize our charging stages and select the best parameters for efficient and safe charging. To achieve this, we implemented internal pre-heating as the best method to heat the battery at freezing temperatures. During the fast charging stage, a lower C-rate constant current was applied to pre-heat the battery, resulting in a temperature rise of 2.5° C. during charging. To prevent degradation of battery capacity, we used short period CC for pre-heating instead of a high CC for a long time. This pre-heating stage was necessary at ambient temperature and helped to acquire good capacity without increasing the temperature too much. After the first pre-heating stage, all discharge and pulse charging stages were designed to overcome lithium plating and acquire maximum capacity. During fast charging at freezing temperatures, the cells were able to gather 55% of charge within 15 minutes 12 seconds, and 65% of charge within 18 minutes 30 seconds after completing a full cycle. The temperature increased from 0° C. to 8.5° C., achieving one of our goals. During fast charging at ambient temperatures, the cells were able to gather 80% of charge within 15 minutes and 90% of charge within 16 minutes 42 seconds after completing a full cycle. The increase in temperature from 25° C. to 37° C. was under control and is a good sign for battery health. The temperature rise during fast charging is a major concern for the development of fast charging techniques.

### Incremental Capacity (IC) Analysis

When secondary species like ions or molecules (intercalants) are inserted into the graphite host structure, they follow a concentration-dependent process called the staging mechanism. Rudorff and Hofmann first discovered this mechanism in 1938 [44], and it's characterized by periodic sequences of intercalant layers, separated by layers without intercalant. These sequences are called ‘nth stage compounds’, where ‘n’ represents the number of graphene layers between two intercalant layers. As the intercalant concentration increases, the number of empty layers between the intercalant layers decreases. Four stages can be observed during Li insertion into the graphite electrode, including SEI and dilute stage formation [45]. A phase transition occurs from the graphite solid solution to stage 4, where lithium ions are intercalated in every fourth inter-slab liquid-like manner. This means that the lithium ions are not perfectly ordered within the layers and are sometimes indicated as L. This phase transition is often called the 1 L to stage 4 phase transition. A first-order phase transition then occurs from Stage 1 L to Stage 4, followed by the transition to Stage 3 along a sloped decrease in potential, known as LiC₂₄ to LiC₁₈ (formation of stage III). Similarly, the transition from LiC₁₈ to LiC₁₂ (construction of stage II) is usually temperature-dependent, and before reaching stage 2, another liquid condition remains, known as 2 L. The evolution from Stage 2 L to Stage 2 includes an increasing lithium content within the same intercalant layers (i.e., every second in the graphite lattice). The final first-order transition to Stage 1 leads to the formation of LiC₆ and provides the largest capacity fraction.

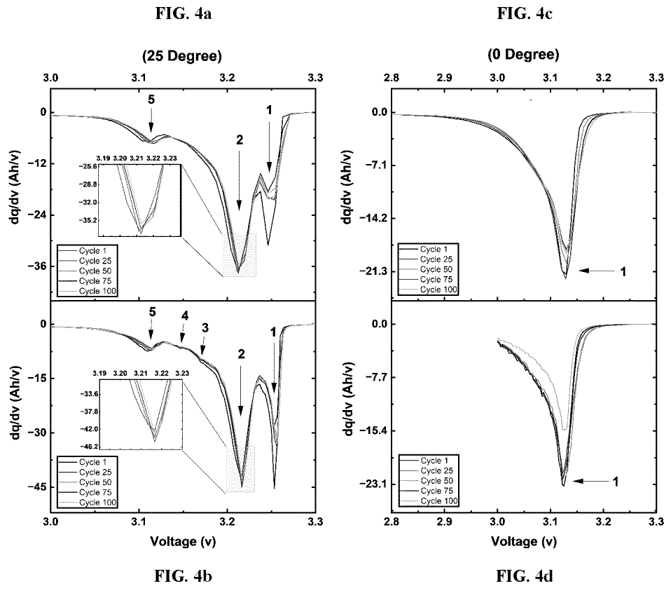

Incremental capacity (IC) represents the change in capacity that occurs when a voltage step is taken. Each peak in the incremental capacity curve has a distinct shape, intensity, and position, indicating a particular electrochemical process within the cell. IC is a good presenter of the loss of lithium inventory, loss of active material, and/or lithium plating. In FIG. 4, four different IC curves are presented for four different conditions. FIG. 4a represents a lower cutoff voltage of 2.5 V with the 25° C. algorithm; FIG. 4b represents a lower cutoff voltage of 3 V with the 25° C. algorithm; FIG. 4c represents a lower cutoff voltage of 2.5 V with the 0° C. algorithm; and FIG. 4d represents a lower cutoff voltage of 3 V with the 0° C. algorithm. FIGS. 4a-d are collectively referred to as FIG. 4.

Every 25 cycles, data were compared for 100 cycles to understand the capacity reduction and lithium plating buildup. Under normal room temperature conditions, 5 peaks can be observed during low C-rate charging and discharging, indicating phase transitions. IC directly relates to the phase change of lithium-ion batteries during charging and discharging. During IC analysis, a decrease in the intensity of IC peaks is proportional to the loss of active material, while the loss of Li inventory is not proportional. Increasing polarization resistance causes the IC peak to shift from its original position. However, if lithium plating occurs, an additional step known as “peak zero” will be added before the first peak. From FIGS. 4, we can see that only FIG. 4b showed all peaks, which in general remain in an IC discharge curve. Other side, only FIG. 4a had three and 4c and 4d had only one peak. During discharge the phase 1 to 2 transition typically occurs after 45-65% SOC. One peak was observed during this charge period, with other peaks arising subsequently. From FIG. 4a we can see peak 1 intensity decreases with the increase of cycle number, indicating a loss of lithium inventory. All other graph included peak 1 and all followed the same pattern of intensity loss, from which a decrease in lithium inventory can be understood to occur with increase in cycle count. It is also known that loss of lithium inventory is a primary cause of capacity loss. For FIGS. 4c and 4d, during a maximum possible charge was 55-63%, resulting in the same discharge amount. In FIGS. 4 and 4b, peak 2 was nearly the same and the position decrement rate was less. Peak 2 intensity loss was due to loss of lithium inventory and at least some loss of active material. FIG. 4b also illustrates a change in peak position indicating that there is less loss of active material. In FIGS. 4a and 4b, peak 5 is shifting towards high voltage side, possibly due to loss of lithium inventory rather than loss of active material. The absence of a peak preceding peak 1 indicates no or negligible lithium plating, which in other approaches can pose one of the principal challenges to fast charging technology of lithium ion batteries. The loss of active material and lithium inventory does degrade capacity, but only minimally over 100 cycles.

### Electrochemical Impedance Spectroscopy (EIS) Analysis

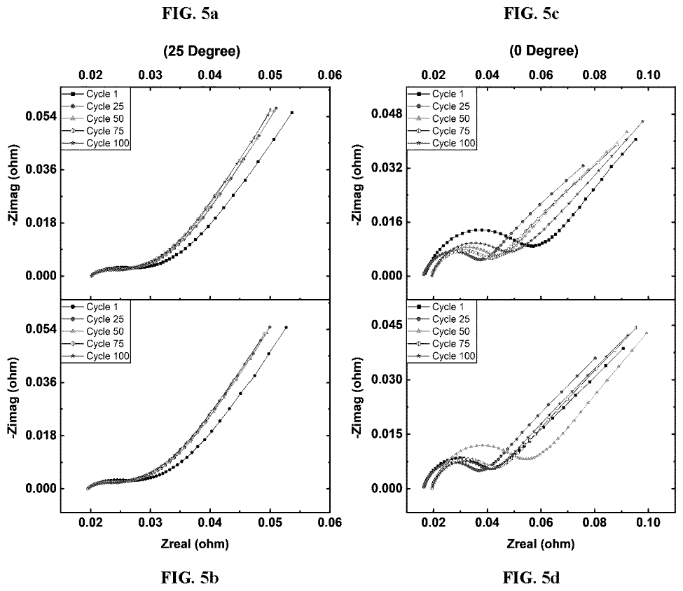

One way to accurately assess the internal electrochemical process in a LIB is through Electrochemical Impedance Spectroscopy (EIS). This method involves applying a small sinusoidal current or voltage to the battery and measuring the resulting output. By analyzing the phase and magnitude of the impedance signal at a specific frequency, useful information can be obtained. EIS is typically conducted across a broad range of frequencies, from mHz to kHz [54]. These findings are showcased and analyzed using a Nyquist plot. This plot helps to distinguish the specific contributions of various electrochemical processes. Regarding cyclic aged cells, particularly those subjected to fast charging or low-temperature charging, there are two characteristics employed to identify lithium plating: increases in Rₒₕₘ (Ohmic Resistance) and R_{SEI} (Solid Electrolyte Interface resistance). As the cycle numbers increase during plating conditions, an increase in Rₒₕₘ can indicate lithium plating. This is because resistance rises due to a decrease in ionic conductivity of the films on the surface of plated lithium also causes an increase in R_{SEI}, which is closely related to LLI. FIGS. 5a-5d present Nyquist plots for 2 different temperatures with two different lower cut-off voltage. FIGS. 5a-5d generally correspond with the same measured conditions as respective FIGS. 4a-4d.

### Ohmic Resistance

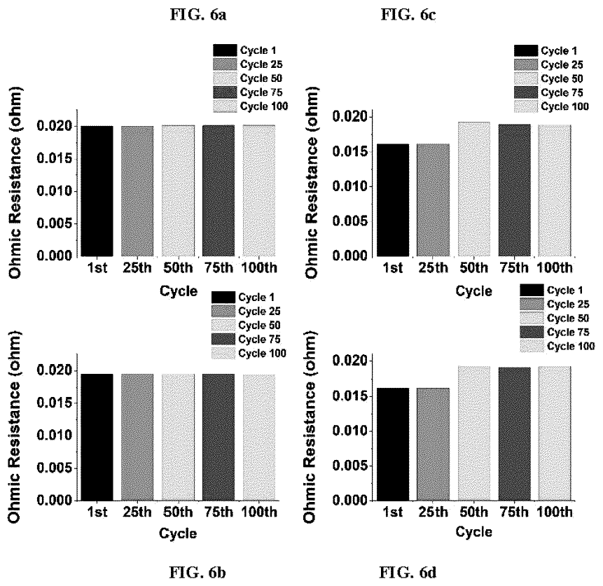

In FIGS. 6a-6d, more detailed information is presented regarding Ohmic resistance. These data were derived from EIS data. Both FIGS. 6a and 6b depict Ohmic resistance under two different conditions at a temperature of 25° C. The first observation is that, there is nearly no difference between Rₒₕₘ. The lower cut-off 3V has little bit less than 0.02 ohm, there lower cut-off voltage 2.5V has 0.02-ohm resistance but the difference is negligible. Usually, Ohmic resistance is utilized to model the resistance in the current collectors, connectors, and electrolytes. Loss of conductivity can occur due to corrosion of current collectors and connectors, as well as changes in electrolyte composites caused by side reactions. This can lead to voltage drops through Ohmic resistance.

An increase in Ohmic resistance can indicate an increase in conductivity loss. It was observed that over a 100 cycle period, the Rₒₕₘ remained substantially constant. There is no change of Rₒₕₘ for two different lower cut-off voltage condition. Data at 25° C., Rₒₕₘ indicates that no significant lithium plating or capacity degradation took place. In FIGS. 6c and 6d, the Rₒₕₘ was compared in two different lower cut-off voltage conditions at 0° C. Initially, the starting Rₒₕₘ at 0° C. was 0.005 ohm less than at 25° C. However, the Rₒₕₘ was less at 0° C. until the 25th cycle, after which it increased by 0.005 ohm and remained constant until the 100th cycle. From the 50th cycle, Rₒₕₘ at 0° C. was same as at 25° C. It should be noted that during fast charging at 0° C. only 63% of the maximum charge was achieved, and at 25° C. only 90%. The increase in ohmic resistance after the 25th cycle indicates that changes occurred in the electrolyte, resulting in a loss of conductivity. Overall, at 25° C., there is nearly significant change in Rₒₕₘ, indicating that less capacity loss occurred during developed fast charging. At 0° C., the increase in Rₒₕₘ initially stabilized after the 25th cycle, indicating either a loss of capacity or conductivity initially, followed by stability.

### SEI Resistance and Charge Transfer Resistance

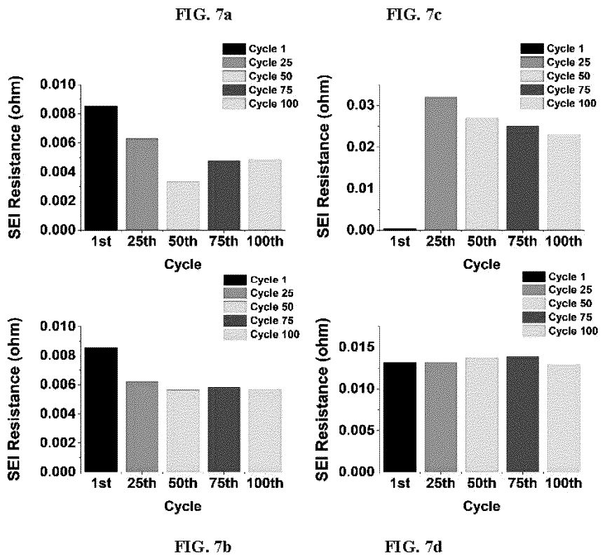

The first semicircle observed in the EIS spectrum comes from the impedance of a layer that forms at the interface between the electrode and electrolyte. This layer is called the solid electrolyte interphase (SEI) layer, and is created by electrolyte decomposition. The SEI layer has a more significant impact on the electrochemical characteristics of the anode material as compared to the cathode material. Characteristics of the layer such as surface coating, gradient, and surface area can change. Monitoring the R_{SEI} (Solid electrolyte interface resistance) can help us observe reversible organic film formation and characteristics of the SEI layer. The second semicircle observed in the EIS results is related to the R_{ct} (charge transfer resistance). R_{ct} is related to the kinetics of an electrochemical reaction and can be altered by surface coating, phase transition, bandgap structure, and particle size. If lithium plating occurs, the resistance of charge transfer should decrease, while the double layer capacitance increases [54]. FIGS. 7a-d presents the R_{SEI} for 0° C. and 25° C. for two different lower cut-off voltages. By comparing the two different lower cut-off voltage at 25° C., it can be seen that R_{SEI} increases rather than decreasing. The loss rate is nearly identical. Only for lower cut-off voltage 2.5V, in cycle 50, is the resistance reduced more than for lower cut-off voltage 3V. Afterwards, the resistance is same for both conditions. Pulse charging may prevent SEI resistance growth. From FIGS. 7c and 7d, two important point can be seen. First: at 2.5V the lower cut-off voltage R_{SEI} is higher than 3V lower cut-off voltage, except in cycle one. In FIG. 7c, from 25 cycle the R_{SEI} initially greatly increases, then decreases. But for FIG. 7d, R_{SEI} appears very stable, with only insignificant growth after 25 cycle. Second: comparing the same lower cut-off voltage for different temperatures it is apparent that, compared to 25° C., starting resistance at 0° C. is high. It indicates that from the beginning at 0° C., for both lower cut-off voltage condition SEI formation is more than at 25° C.

The formation and buildup of SEI is a significant aging mechanism in LIB. SEI hinders the process of intercalation and de-intercalation of LIB between the electrolyte and the anode, resulting in a loss of lithium-inventory (LLI). This leads to a decline in capacity and increased resistance. The increase in R_{SEI} is caused by LLI. Here at 0° C., LLI is greater than at than 25° C., which can affect in future for capacity reduction. But during our charging operation period, the change of resistance is not significant, indicating that the charging technology disclosed herein can prevent rapid capacity degradation.

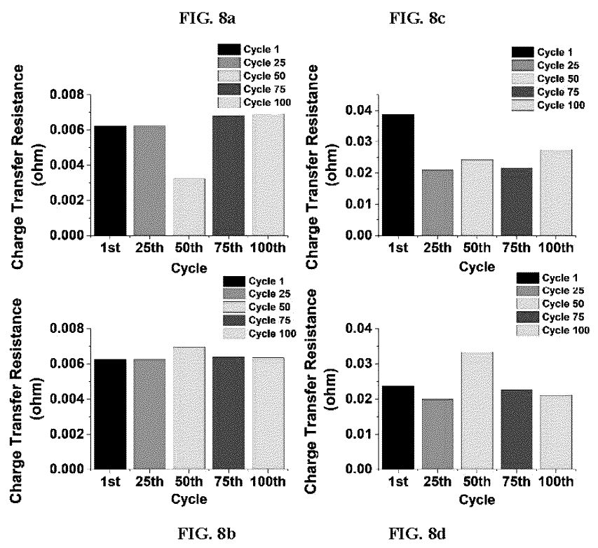

R_{ct} for 0° C. and 25° C. is presented in FIGS. 8a-8d. FIGS. 8a and 8b present Rat for 2.5V and 3V lower cut-off voltages at 25° C. As shown in these figures, R_{ct} growth generally indicates that there is possibility of LLI, and at 2.5V lower cut-off voltage the reduction of resistance indicates that there is possibility of gain of lithium inventory. FIGS. 8c and 8d present the R_{ct} for 2.5V and 3V lower cut-off voltages at 0° C. By comparing the same lower cut off voltage for different temperature we can see, compared to 25° C., that the starting R_{ct} at 0° C. is high. This indicates that the present approach reduces R_{ct}, rather than increasing it.

### Warburg Impedance

At low frequencies, Warburg impedance (R_{W}) is linked to the movement of lithium-ions through diffusion. When the concentration level within a Li-ion particle varies, it triggers diffusion, which in turn leads to structural changes in the particle. Since diffusion processes are connected to the morphological alterations in the electrodes, the rise in R_{W} can be mainly attributed to Loss of active material (LAM). FIGS. 5a and 5b show substantially the same Walburg resistance (except in cycle one). FIGS. 5c and 5d show that diffusion resistance is higher for both cut-off voltages of 2.5V and 3V at 0° C. LAM can consequently also be understood to be higher in this condition compared to the others, indicating that diffusion resistance can impact capacity degradation in cold temperature.

### Life Cycle Analysis

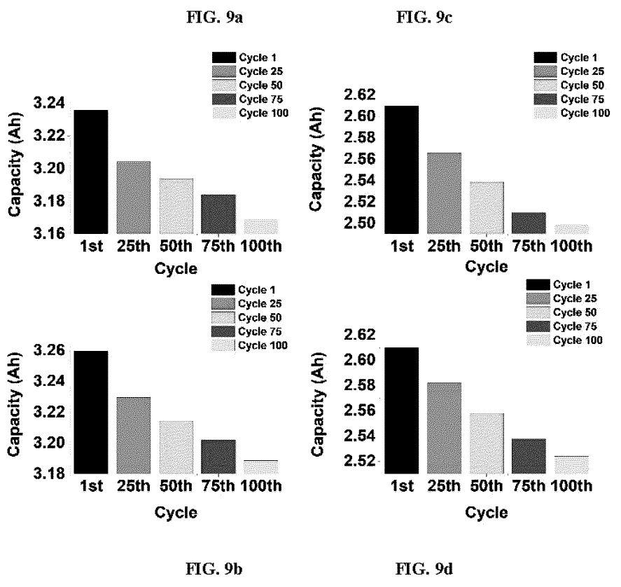

Testing was conducted under two different testing conditions at 25° C. and 0° C. to analyze the capacity degradation rate of our cells after applying our fast charging technique for 100 cycles. FIG. 9a shows that, at 25° C., for a lower cut-off voltage of 2.5V, the initial discharge capacity was 3.23 Ah, indicating a capacity of 100.9%. After 100 cycles, the capacity reduced to 3.17 Ah, which is 99% of the capacity. The capacity reduced by 1% from the nominal capacity of the cell and by 1.9% from the testing discharge capacity. FIG. 9b illustrates that at a lower cut-off voltage of 3V, the initial discharge capacity was 3.25 Ah, indicating 101% capacity. After 100 cycles, the capacity reduced to 3.17 Ah, which is 99.37% of the capacity. The capacity reduced by 0.63% from the nominal capacity of the cell and by 1.63% from the testing discharge capacity. We observed that a lower cut-off voltage resulted in a higher capacity reduction rate, with a 0.3% more reduction for 2.5V cut-off voltage than 3V cut-off voltage. However, the capacity reduction rate was small for both conditions, indicating that the LLI and LAM were minimal. Additionally, since both cells had a maximum charge of nearly 90%, they were protected from overcharge, which prevented capacity reduction.

FIG. 9c shows that, at 0° C., for a lower cut-off voltage of 2.5V, the initial discharge capacity was 2.61 Ah, indicating a capacity of 81.6%. After 100 cycles, the capacity reduced to 2.5 Ah, which is 78.13% of the capacity. The nominal capacity of the cell was 18.4% less than normal conditions from the beginning, and during testing, the discharge capacity reduced by 3.47%. FIG. 9d shows that at a lower cut-off voltage of 3V, the initial discharge capacity was 2.61 Ah, indicating 81.6% capacity. After 100 cycles, the capacity reduced to 2.52 Ah, which is 78.75% of the capacity. The nominal capacity of the cell was 18.4% less than normal conditions from the beginning, and during testing, the discharge capacity reduced by 2.85%. Similar to 25° C., we observed that a lower cut-off voltage resulted in a higher capacity reduction rate, with a 0.6% more reduction for 2.5V cut-off voltage than 3V cut-off voltage. However, the maximum achieved charging was 63% during the presently disclosed charging technique, and the cell capacity was less from the beginning due to high cell resistance. Moreover, during cycling at 0° C., we observed LLI following the IC analysis, indicating that LLI was the main impact factor for cell capacity reduction during our fast charging technology application. As a result, we observed high R_{SEI} and Rct at 0° C.

### SUMMARY

As noted above, it has been reported that batteries tend to age more quickly in low temperatures than at ambient temperature. This is due to low-temperature degradation, which occurs during charging and is caused by lithium deposition (plating). This is more likely to happen in the anode due to its higher resistance at low temperatures. It is not yet well understood how lithium ion cells degrade under low-temperature conditions compared to high-temperature degradation. Lithium plating is a particularly severe degradation mechanism for Li-ion cells as it can cause significant capacity fade and compromise the safety of battery systems. Lithium plating can occur when Li-ion cells are exposed to low temperatures and high charging currents. Lithium plating occurs when metallic lithium deposits on the negative electrode surface during the charging of Li-ion cells. This happens when the negative electrode's potential drops below 0V vs. Li/Li+, which makes the deposition of metallic lithium thermodynamically feasible. The negative electrode may become over-polarized, causing metallic lithium to form around the negative active material. This results in an increase in electrolyte reduction, reducing the amount of available lithium and the cell's capacity, which fades over time. Furthermore, lithium dendrites may penetrate the cell separator, causing internal short circuits that can trigger thermal runaway. It is crucial to develop a fast charging method that can efficiently charge the battery in freezing and room temperatures without compromising its lifespan. The fast charging approach disclosed herein offers faster charging without sacrificing cycle life. As evidenced herein, this charging technology performed successfully in observed capacity degradation out to at least 100 cycles.

### The Impact of Temperature and Charging Rate on the Heat Generation of the LFP Battery

The operating temperature of lithium-ion batteries is an essential factor influencing the performance of electric vehicles. The low and high temperatures both have an inverse effect on battery health. Another temperature impact people need to understand is the immediate temperature freezing to room temperature shift effect on a lithium-ion battery. During charging and discharging, battery temperature varies due to internal heat generation, calling for analysis of the battery heat generation rate. The generated heat consists of reversible and irreversible heat, which are affected by various factors, including temperature, state of charge (SOC), and operation C-rate. As set forth below, experiments were carried out on a Lithium iron phosphate (LFP) battery, testing it under three different temperatures: freezing, room temperature, and 15 minutes after a shift from freezing to room temperature. This testing analyzed the reversible heat, irreversible heat, and total heat generation rate, taking into account the effects of temperature, SOC, and current. Results showed that, compared to 25° C., the internal HGR was almost 93% lower at 0° C. and almost 88% lower 15 minutes after a shift from 0° C. to room temperature. Surface temperature showed almost no difference. At 15 minutes after 0° C., the surface temperature was nearly the same as at 25° C., while the internal HGR was only half that at 25° C. Additionally, the CC-CV charging method was unable to charge the battery to 100% after 15 minutes at 0° C.

The Lithium-ion battery (LiB) has gained popularity as the go-to energy storage option for portable electronics due to its high working potential, energy density, power density, low self-discharge, and long lifespan. Since its commercialization in the early 1990s, LiB has been widely used in devices like mobile phones and cameras. LiB has broadened its applications through extensive research and development, now encompassing electric vehicles (EV), hybrid electric vehicles (HEV), and large-scale energy storage power stations. As a complicated electrochemical power source, a lithium-ion battery's operating temperature and charging/discharging rate greatly affects its performance. The temperature at which a battery operates significantly impacts chemical reactions, ion transport, and the intercalation and deintercalation process. This, in turn, affects the efficiency, cycle life, and degradation of battery systems. When the temperature decreases, the battery's internal resistance increases while the available capacity decreases, reducing the battery's available energy and maximum power. The low temperature is one of the biggest challenges for LiB. The discharge capacity of LiB gets lower at low temperatures. As a result, EV driving range and acceleration performance are strongly affected under low temperatures. At high temperatures, however, LiB suffers from safety and aging problems. The temperature of LiBs changes not just due to external factors, but also because of the heat produced during charging and discharging. This is supported by several studies. Numerous research studies have explored the significance of the heat generation rate of LiB during charging and discharging under varying thermal conditions and currents. The growing need for fast charging technology has resulted in a greater demand for precise and advanced thermal management systems for LiBs, which are crucial for extending LiB lifespan and ensuring safety. Efficient temperature control is essential for implementing the appropriate fast charging techniques. Researchers closely monitor temperature changes during various studies aimed at developing fast charging algorithms. The Bernardi and Newman et al. model is currently the most widely used for battery heat generation rate. It divides the process into two parts: reversible and irreversible heat generation. The electrode reaction causes reversible heat generation, mainly determined by the voltage temperature coefficient (dE/dT). This entropy change heat generation is part of the reversible process. The internal resistance of a lithium-ion battery is primarily affected by temperature and state of charge (SOC). Generally, the resistance increases as the operating temperature decreases and varies across different SOC levels. However, the specific impact of temperature and SOC on the internal resistance of different lithium-ion batteries varies considerably due to differences in cell chemistry and production. In order to achieve fast charging, a high C-rate is typically necessary. However, it's important to consider the battery's thermal safety as heat generation increases significantly at high C-rates, particularly during fast charging. Different research conducted on the operating temperature and surface heat of lithium-ion batteries, and the results showed that reversible heat generation greatly influences temperature distribution. According to the research conducted by Renfeng Cao et. al., the heat generation capacity of a battery is significantly impacted by ambient temperature, discharge current, and cycle aging. Their research conducted between 25 to 45 degree Celsius. Chongtian et. al. after experiment heat generation behavior on 18650 LiB under 108 operating condition found that ambient temperature and discharge current has a great influence on heat generation. Chen et al. examined the heat generation rate and efficiency of a 20-Ah LiFePO4 lithium-ion pouch cell under various temperatures (−10 to 40° C.). It was demonstrated that there was a direct correlation between the discharge current rate and the amount of heat generated. Other research present that temperatures outside of −10 to 60 degrees Celsius can have negative effects on Li-ion batteries. At lower ambient temperatures, the internal resistance of the battery increases, causing a greater temperature increase and resulting in more heat generation. Additionally, the cold temperature affects the battery's uniformity by creating temperature and voltage differences, which worsens with an increase in cycle rate. Alongside different real physical testing different model had developed to understand the thermal behavior. As the temperature of battery temperature continues to increase, a variety of side reactions will occur inside lithium-ion battery. The LiCoO₂ battery model was established by Andreas et al. According to simulation results, the overall temperature of the lithium-ion battery increased quickly when the solid electrolyte interface (SEI) membrane started to decompose. Another used a simulation method to study the change in heat production of lithium-ion batteries in an oven. The findings revealed that at 463 K, a strong heat-generating chemical reaction caused the battery temperature to rise rapidly under normal heat and air convection heat-transfer conditions. The temperature distribution of different types of batteries at different charging rates and found that the temperature of various types of batteries increased rapidly with an increase in charging rate. According to some research, the SOC of a battery decreases and the temperature increases during continuous discharge until the battery is fully drained. At the beginning of discharge, the SoC is high and the temperature is low, while towards the end of discharge, the SOC is low and the temperature is high. This means that heat generation is influenced by both the SoC and operating temperature during continuous discharge. In real-world scenarios, batteries are often operated at different SoC levels and temperatures. Therefore, it is important to examine the individual effects of SOC and temperature on heat generation. In general, the studies mentioned above maintain a constant temperature for a few hours to allow the battery to adjust to both external and internal temperatures. In practical use, however, sudden temperature changes may occur. If a rechargeable device is kept in cold temperatures for an extended period of time and is suddenly brought to room temperature for charging, the effects of different charging rates are have not been well understood.

The testing described below is provides insight into the various effects of charging and discharging C-rate and temperature on LFP batteries. Correlations between the rate of heat generation and SOC are analyzed below. Additionally, if a battery is exposed to cold temperatures for a prolonged period and then brought to room temperature for charging, it may experience varying charging rates.

### Methodology

When a battery undergoes a current/voltage perturbation (ΔV/ΔI), its DC resistance is determined by the ratio of voltage to current. This voltage drop is affected by various phenomena. Firstly, the pure Ohmic resistance, which includes all electronic resistances and the bulk electrolyte ionic resistance, contributes to the rapid voltage drop. Secondly, the voltage drop in the initial few seconds is due to the battery's double-layer capacitance and charge transfer resistance, resulting from the charge transfer reaction at the electrode/electrolyte interface. Lastly, the voltage drop is due to polarization resistance, which accounts for ionic diffusion in the solid phase and is the rate-determining step for Li-ion batteries. These three components can be calculated separately to understand the complex electrochemical processes involved in a battery system. However, calculating the bulk total cell resistance from the total voltage drop for the pulse can pose a challenge because it is difficult to separate the different resistance components imposed by DC. Multiple discharge/charge pulses of different amplitudes can also be used to determine internal cell resistance. Still, it is essential to ensure that the voltage response remains linear and that the battery does not reach a limit of diffusion. A battery's DC internal resistance (DCIR) is a crucial parameter for measuring its performance and estimating its common factors such as available capacity, SOH, and SOC. An increase in DCIR usually accompanies a reduction in capacity during degeneration, whereas low DCIR indicates a high capacity and strong discharge capability. The following equation 1, calculates DCIR:

$$D C I R = \frac{{V}_{1} - {V}_{2}}{{I}_{1} - {I}_{2}} \qquad ( Equation 1 )$$

where V₁ is the terminal voltage of the cell at end of the application of current during the pulse period, V₂ is the voltage at the start of rest period during pulse, I₁ is the current value at the end of application of current and I₂ is the current at the start of rest period during pulse period.

### Theoretical Analysis of Heat Generation

Electric energy is transformed into chemical energy stored within the battery when a battery is charged. The stored chemical energy is then converted into electric energy to provide power during discharge. However, heat is generated during both the charging and discharging stages. The heat generated can be classified into four parts and represented by the following equation:

$$Q = I ( V - U ) - IT \frac{dU}{dT} - {\sum }_{i} Δ {H}_{i}^{avg} {r}_{i} - \int {\sum }_{j} ( {\overline{H}}_{j} - {\overline{H}}_{j}^{avg} ) \frac{{dc}_{j}}{dt} dv \qquad ( Equation 2 )$$

As is well known, the heat generation of a full cell is mainly dominated by two factors, namely, reversible and irreversible heat. The reversible heat is related to the chemical reactions in cells, while the irreversible heat is related to concentration polarization, activation polarization, and ohmic polarization. On the right side, the first term is the heat generated from resistive dissipation, called irreversible heat and always positive. The second term is entropic, reversible heat. The third term represents the heat produced or consumed by any chemical reaction. The last term accounts for the heat of mixing. The amount of reversible heat is dependent on the entropic coefficients, which are associated with the open-circuit voltage at various temperatures. The reversible heat is connected to the insertion and extraction of Li-ion between the anode and cathode. This process is related to the change in entropy and is reflected by the temperature coefficient. On the other hand, the internal resistance determines the amount of irreversible heat. Compared to the first and second terms, the third and last terms can be neglected under normal operating, and the following simplified expression of the heat generation rate is given as follows:

$$Q = I ( V - U ) - IT \frac{dU}{dT} \qquad ( Equation 3 )$$

In battery technology, the symbols I, U, V, T, and dU/dT represent the operating current, open voltage, operating voltage, ambient temperature, and voltage temperature coefficient, respectively. The total heat generation can calculate by equation 3. The over-potential of the battery is critical in determining the internal heat generated during charge and discharge. The battery's internal resistance includes joule, polarization, and contact resistance and is the overall resistance of the battery. Polarization heat comprises two parts: the heat dissipated due to the electrode redox overpotentials and Joule heating in the cell. Therefore, the internal resistance is a key factor in calculating the irreversible heat. The reversible heat depends on the insertion and extraction of Li-ion between the anode and cathode, which is related to entropy change and reflected by the temperature coefficient. Both internal resistance and voltage temperature coefficient are assumed to be functions of temperature, and the heat generation rate is a quadratic function of the current under isothermal conditions. The effect of temperature on heat generation is more complex since both the internal resistance and voltage temperature coefficient change as the temperature changes. Equation 4 presents the simplified version of equation 3:

$$Q = {I}^{2} R - IT \frac{dU}{dT} \qquad ( Equation 4 )$$

If heat is not removed correctly, thermal runaway may occur. This happens when elevated temperatures trigger other heat-generating reactions, increasing the battery temperature even more. This creates a feedback loop that causes the battery temperature to rise unless the heat is dissipated well sharply. If thermal runaway occurs, the cell may fail, leading to fire or explosive gas release. Even if thermal runaway does not occur, consistently operating the battery at elevated temperatures (>50° C.) can significantly degrade its capacity.

### Experimental Setup

The experimental apparatuses used were the Neware CT4008-10V50 A-NTA Battery Testing System, which was used to carry on the charge-discharge cycle tests, the thermocouple and data acquisition instrument, which was used to monitor temperature in real time. Here standard CC-CV method for charging and CC for discharging applied battery testing. Two general and one unique temperature had applied to test the battery. Three different temperatures were 0 Degrees, 25 Degrees, 15 minutes after 0 Degrees Celsius. For CC stage 1C-4C (3.2 A-12.8 A) rate current had applied for charge and discharge. Battery testing thermal chamber had used for maintain the temperature constant. At 0 degree and 25 degree Celsius, before starting the charging and discharging cycle, battery had kept for 2 hours to absorb the temperature. Parameters applied for testing is provided into table 1.

TABLE 1
Experimental Parameters

| | | Value | | Temperature | Cut-off | |
|---|---|---|---|---|---|---|
| Step | Item | (C-rate) | | (Degree Celsius) | voltage/current | |
| 1 | Constant | 1 C, 2 C, | | 0 Degrees, | 3.65 | V |
| | current | 3 C, 4 C | | 25 Degrees, | | |
| | charge | | | 15 minutes | | |
| | (CC) | | | after 0 | | |
| | | | | Degrees | | |
| 2 | Constant | 3.65 | V | | 0.03 | A |
| | voltage | | | | | |
| | charge (CV) | | | | | |
| 3 | Resting | 30 | minutes | | | |
| 4 | Constant | 1 C, 2 C, | | 0 Degrees, | 2 | V |
| | current | 3 C, 4 C | | 25 Degrees, | | |
| | discharge | | | 15 minutes | | |
| | | | | after 0 | | |
| | | | | Degrees | | |
| 5 | Resting | 30 | inutes | | | |

### Results and Discussion

### Effect of Different C-Rate on Surface Temperature Change and HGR During Charge/Discharge at 0 Degree Celsius

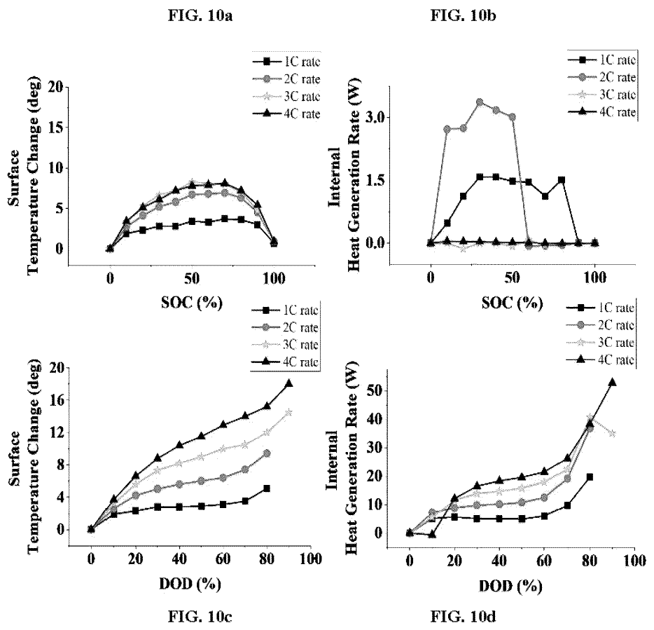

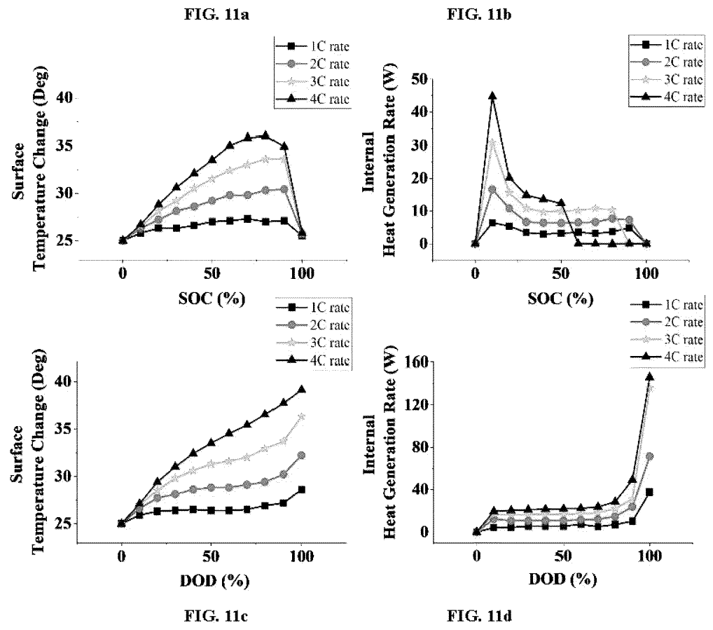

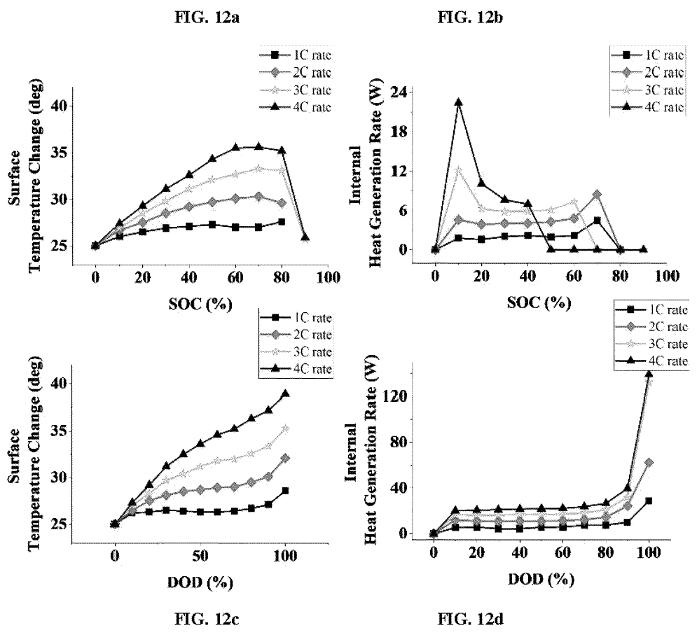

The amount of heat produced by lithium-ion batteries is affected by their operating current and temperature. To better understand the impact of current, four different C-rates were examined under three different temperature conditions. As shown in FIG. 10a, only the 1C and 2C rates could charge in CC stage at 0 degrees Celsius, reaching up to 80% and 50% SOC respectively. The 3C and 4C rates required CV stage charging due to their terminal voltage touching the upper cut-off voltage within 30 seconds of the CC stage. During 3C and 4C rate charging, the CC stage charging cannot last for an extended period. The HGR remained higher than the temperature rises during the 1C rate until CV stage started, and continued until 20% after which the temperature began to drop, as shown in FIG. 10b. The HGR was higher during the 2C rate, but a sudden fall in HGR was observed from 60-100% SOC during the CV charging stage. For the 3C and 4C rates, the CC stage lasted less than 30 seconds, and all charging took place during the CV stage, resulting in a lower HGR compared to the 1C and 2C rates. The HGR is highly affected by the CC and CV stages and, as can be seen in FIGS. 10a-d, HGR dropped dramatically during the CV stage. Conversely, however, surface temperature continued to rise with increases to C-rate. As can be seen from FIGS. 10a-d, the CC stage lasted for only a short time but had an impact that through the CV stage. Temperature changed four times more than the 1C-rate during charging, similar to the C-rate. The surface temperature change for charging at rates of 3C and 4C was almost identical and had a differed by less compared to charging at a rate of 2C. However, there is a significant gap in temperature change when charging at a rate of 1C compared to the other rates. This suggests that designing a charging algorithm based solely on surface temperature may not be the best approach.

CC is used to discharge the battery at 0 degree Celsius and FIGS. 10c and 10d respectively showed surface temperature change and HGR in different DOD (Depth of Discharge). During a 1C-rate discharge, HGR remains low until 60% DOD, after which there is a sudden increase in HGR until 80% DOD. The maximum discharge capability at 1C and 2C rate of the battery at 0 degrees Celsius is 80% DOD with 20% charge remaining in the battery after the discharge voltage reaches the lower cut-off voltage. The pattern of temperature rise and heat generation rate appear to be very similar. During a 2C-rate discharge, HGR is twice that of a 1C-rate discharge, with the temperature rising 4 degrees Celsius more than in a 1C-rate discharge. HGR increases linearly until it reaches 60% DOD, after which it rapidly increases, similar to a 1C-rate discharge. The temperature rise shows the same behavior. It was observed that during 3C and 4C discharge rates, the battery discharges 10% more than 1C and 2C rate discharge rates. During a 3C-rate discharge, HGR is the same as during a 2C-rate discharge, but the temperature rises 10 degrees Celsius more than during a 1C-rate discharge and 6 degrees Celsius more than during a 2C-rate discharge. HGR consistently increased until it reaches 70% DOD, after which a sudden increase is observed from 70% DOD to 80% DOD. From 80% DOD to 90% DOD, there is a small drop in HGR. There is a slight heat absorption occurring during this period. During a 4C-rate discharge, the temperature rises more than 12 degrees Celsius and HGR is three times more than during a 1C-rate discharge. Temperature rise is linear, and HGR is nearly linear up to 70% DOD and higher from 70-90% DOD. The plane region is due to the endothermic process of electrode material during discharge. This indicates that if temperature rise during discharge at freezing temperature can able to discharge more. From result analysis it observes that greater than 3C rate is good for freezing temperature discharge.

Based on the temperature changes during charging and discharging, we can conclude the following: 1) When comparing the constant current charging and discharging process, the charging process was shorter, never reached to 100% DOD, and a quicker temperature rise rate at all rates during discharge but compare to discharge nearly two times less temperature rise during charge. 2) At 50% SOC/DOD, the surface temperature of the battery had less difference. 3) When discharging a battery, the HGR rate and surface temperature rise more as the C-rate increases. CC tends to be more stable during discharge than charging, resulting in a more stable HGR and temperature change. During the charging CV stage, the voltage remains constant, but as the current decreases, HGR begins to show a downward trend or heat absorption, and the temperature starts to decrease instead of rising. However, as the discharge rate increases, the temperature rise and difference in temperature within the battery increase quickly. This leads to an inhomogeneous distribution of the battery, causing uneven material utilization, capacity degradation, performance reduction, and ultimately battery failure, including thermal runaway. When the temperature is low, the voltage hits the cutoff point sooner because of an increase in ohmic over-potential. As a result, the total heat decreases at lower temperatures due to a reduction in discharging time.

### Effect of Different C-Rate on Surface Temperature Change and HGR During Charge/Discharge at 25 Degree Celsius

Manufacturers typically recommend charging and discharging lithium-ion batteries at a temperature of 25 degrees Celsius for optimal performance. Temperature plays a significant role in heat generation and achieving maximum SOC during the CC stage, as shown in FIG. 11a-d. As shown in FIG. 11a, when charging at a 1C rate, the temperature only rose by 2.4 degrees Celsius for a full 100% SOC, but the HGR rate was high presented in FIG. 11b. HGR remained high during the first 30% SOC, alleviated between 30-70%, and then had a small increase from 70-90%. HGR slightly decreased during the final 10% charge, which was done through CV, and the temperature also decreased during that time. Charging at a 2C rate resulted in a temperature increase of 4 degrees Celsius more than the 1C rate, and the HGR was more than double that of the 1C rate charging. HGR remained high during the first 30% SOC, stabilized between 30-70%, and then had a small increase from 70-90%. The temperature increased linearly during the constant CC stage and peaked between 30-70% SOC. Resistance initially increased from 20 to 30% SOC, remained stable, and then grew from 70-100% SOC. Therefore, for the first and last 30% SOC, the terminal voltage change is rapid and the HGR is high compared to 30-70% SOC. Charging at a 3C rate resulted in the HGR being 5 times higher than 1C rate charging. The temperature increased linearly until reaching 80% SOC, and was 7 degrees Celsius higher than 1C rate charging. Compared to 1C and 2C charging rates, during 3C and 4C rate charging, the stored charge was 10% less and reached the cut-off voltage at 80% SOC, and the CC stage became smaller and stayed at 50% SOC for 4C rate charging. The heat generation rate was observed during the first 20% SOC. However, compared to 1C and 2C, the temperature did not drop suddenly during the CV stage during 3C and 4C rate charging. Lastly, during the last 10% SOC, the temperature drop was nearly similar for all charging conditions. The information provided in FIG. 11d indicates that there is minimal variation in HGR within each 10% DOD range until 70% DOD. However, beyond this point, there is a noticeable upward trend for all four C-rate discharging scenarios. Specifically, when comparing HGR between 1C rate and 4C rate, the latter shows four times higher HGR. It is important to note that for 4C rate discharging, there is a consistent increase in temperature, which reaches almost 16 degrees Celsius, provided in FIG. 11c. Likewise, for discharge rates ranging from 1C to 3C, both HGR and temperature rise increase consistently until 70% DOD, following which they undergo a sudden increase from 70-100% DOD.

After analyzing the temperature changes during charging and discharging, we have come to several conclusions. Firstly, the CC charging process becomes shorter as the C-rate increases, while also having a higher peak temperature and quicker temperature rise rate at all rates. Secondly, the surface temperature of the battery remains similar at 50% SOC/DOD. Thirdly, the HGR is higher during the first 10% SOC and last 10% DOD during discharge. It support that throughout a complete cycle of a commercial cell, lithium intercalation takes place in the negative electrode during the charging process, while in the positive electrode during discharge. Consequently, the majority of heat generation occurs in the negative electrode during charging and in the positive electrode during discharge. Fourthly, CC tends to be more stable during discharge than charging, resulting in a more stable HGR and temperature rise. Finally, 100% charge and discharge is achievable at 25 degrees Celsius. During the charging CV stage, the voltage remains constant and HGR shows a downward trend as the current decreases, resulting in a decrease in temperature. However, as the discharge rate increases, the temperature rises quickly, causing an inhomogeneous distribution of the battery, which ultimately leads to uneven material utilization, capacity degradation, performance reduction, and battery failure, including thermal runaway.

Effect of Different C-Rate on Surface Temperature Change and HGR During Charge/Discharge at 15 Minutes after 0 Degree Celsius

A common need exists to charge rechargeable systems from cold temperatures to room temperatures, which can take around 15 minutes after 0 degrees. However, sudden temperature changes can have a significant impact on the battery's health. This is called a thermal condition, where the battery's surface temperature remains at 25 degrees Celsius but is unable to absorb the full ambient temperature and begin charging. Charging at 0 degrees Celsius is difficult, but during testing found that CV charging can still fully charge the battery. However, 15 minutes after 0 degree Celsius in room temperature, the battery had not reached 100% charge for C-rates between 1C to 4C. FIG. 12a shows both 1C and 2C rates charging at the CC stage charge to 70% SOC, with the last 10% charge is done in the CV stage. As a result, HGR increases until 70% SOC and then drops from 70 to 80% SOC presented in FIG. 12b. For 3C and 4C rate charges, it was possible to charge up to 90% SOC, but CC stage SOC was 60% for 3C rate and 40% for 4C rate charge. In this case, the HGR for 4C rate charging is five times higher than for 1C rate charging, with a temperature rise of nearly previous 25 degrees Celsius condition.

FIG. 12c similarly illustrates discharge at 25 degrees Celsius condition testing, but at the 1C rate. As shown in FIG. 12d, heat generation rate (HGR) from 1C to 4C rate discharge is nearly unchanged. This is achievable because it stays at 25 degrees Celsius for an extended period during charging and spends some time resting before discharging. Consequently, the discharge behavior becomes quite comparable to discharge at 25 degrees Celsius condition. This indicates that 15 minutes of charging after 0 degrees produces different operating conditions from 25 degree Celsius. Initially, the temperature gradually increased and the variation between various SOC charges was minimal. As the reaction progressed, however, the temperature rose at a faster rate. During charging phases, a temperature increase occurred once the CC stage was complete, resulting in a disparity between the maximum temperature and the temperature at the completion of the CC stage. The maximum rate of increase of temperature was reached at the moment when constant current charging transforming to the constant voltage charging during, and was reached at end of discharge. Consequently, the maximum temperature is attained after both charging and discharging, due to the disparity between heat dissipation and heat generation. The battery accumulates heat which gradually dissipates into the surrounding environment. As the discharge rate increases, battery temperature rises faster possibly due to the continuous increase in the thickness of the solid electrolyte interface film (SEI film) with rising surface and internal temperature. This results in an increase in internal resistance and the generation of more heat, causing a higher rate of heat generation due to irreversible heat. Additionally, the temperature generated during discharge increases at a faster rate than during charge, as the open circuit voltage experiences a significant drop at low state of charges. When the charging and discharging rate is increased, the maximum temperature on the surface also increases while the uniformity of the temperature field worsens. This is due to the fact that increased current leads to more polarization and the generation of additional joule heat and polarization heat. Additionally, the time frame for heat dissipation becomes shorter, making it challenging for the heat to spread quickly. However, if the temperature becomes too high, it can alter the crystalline form of the cathode material and intensify heat release in the reaction between the cathode and electrolyte. This can lead to possible thermal runaway of the lithium-ion battery, ultimately causing security issues.

### Analysis of Correlation Between SOC/DOD and Ratio of Reversible and Irreversible Heat Under Different Operating Condition

### Ratio of Reversible and Irreversible Heat at 0 Degree Celsius

The rate at which heat is generated is a combination of two types of heat: reversible and irreversible heat. Irreversible heat, also known as Joule heat, refers to the heat loss in a battery that cannot be recovered. It is always positive and increases with the current rate. It is directly related to the internal resistance of the battery. On the other hand, reversible heat refers to the heat generated during chemical reactions that occur during charging and discharging. This type of heat can be positive or negative depending on whether heat is generated or absorbed. The total of reversible and irreversible heat during charging and discharging at different SOC and DOD indicates the final absorbed or generated heat at that specific SOC/DOD. This information is essential for designing an appropriate charging algorithm and thermal management system.

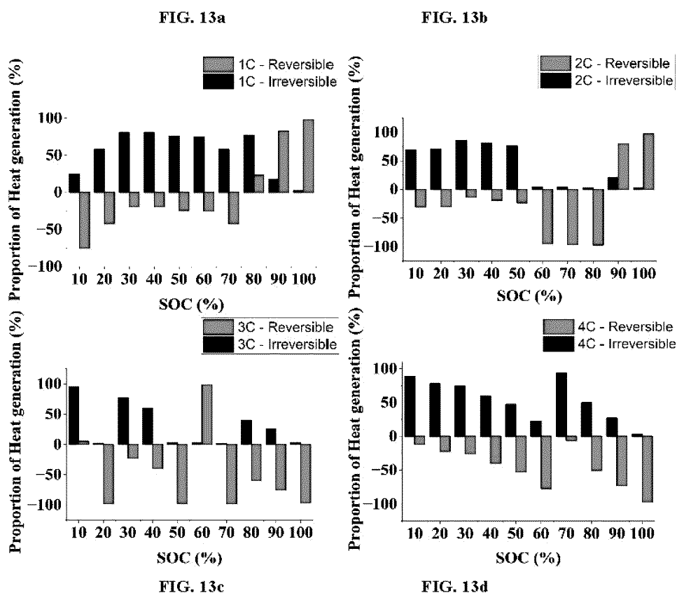

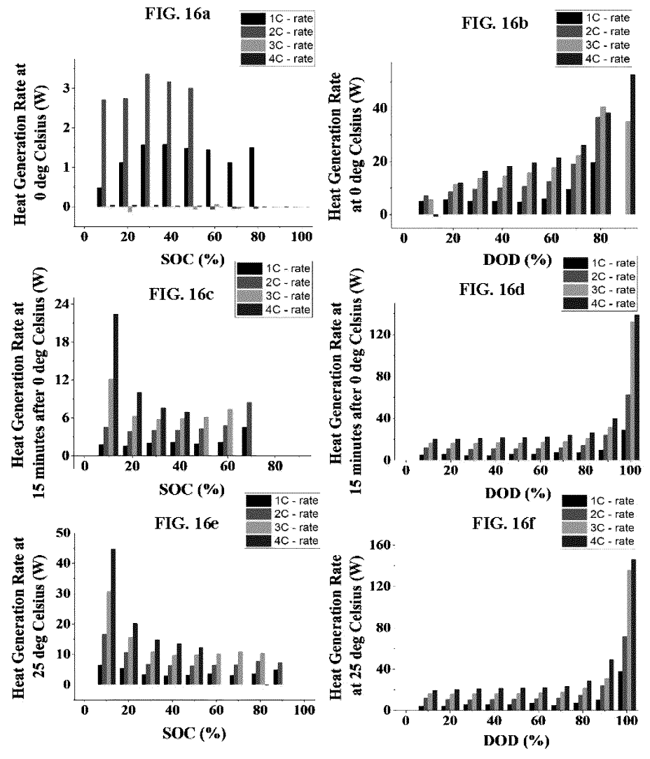

FIGS. 13a-d show heat generation during charging at 0 degrees Celsius for charging rates of 1C to 4C. It can be observed that irreversible heat dominates until 80% state of charge (SOC), while a large portion of reversible heat is absorbed until 70% SOC. Consequently, a large number of heat losses occur during charging as irreversible heat generation dominates. The battery can absorb the generated heat as it operates at 0 degrees Celsius. After 80% SOC, the constant voltage (CV) stage charge begins, and reversible heat dominates, but the heat generation rate is low. During 0-degree Celsius charging at different C-rates, it was observed that for 1C and 2C rates, a significant amount of reversible heat was absorbed until 70% and 50% SOC, respectively. This heat absorption took place at the beginning of charge and it is possibly the time period of resistance rise to stable condition. However, during CC charging, irreversible heat generation produces a lot of heat, leading to an upward heating curve. The heating pattern for 3C-rate charging was slightly different from others, with heat absorption dominating. During CV stage charging, heat generation was poor, and heat absorption played a vital role during 3C and 4C-rate charging where maximum heat was generated for the CV stage. FIGS. 16a, 16c, and 16e show the relationship between HGR and SOC more precisely. From these figures, it can see that heat absorption played a vital for all three different C-rate charging and its impact can see in FIG. 16a. Following the thermodynamic rule, it can happen that, as the environment is freezing for that generated heat absorbed by the cold temperature faster.

Up to 60% DOD at 1C rate discharge, irreversible heat is the primary source of heat generation, with no heat absorption occurring throughout the discharge period. For 2C to 4C discharge, reversible heat absorption occurs during the chemical reaction, but some irreversible heat is still generated. As the discharge rate increases during the 20% DOD period, the heat absorption portion also increases. The overall discharge process is significantly influenced by the generation of irreversible heat. As irreversible heat is related to applied current and resistance, for that as C-rate increase the total irreversible heat increase. But as open circuit voltage changes faster during fast discharge, as a result entropy change happen quickly. This quick change of entropy tends to heat absorption. For all different C-rate after 50% DOD, heat absorption starts to dominant. It indicates that open circuit voltage changes faster after 50% DOD. In FIG. 16b, an upward trend of heat generation accompanies the increase in C-rate.

### Ratio of Reversible and Irreversible Heat at 25 Degree Celsius

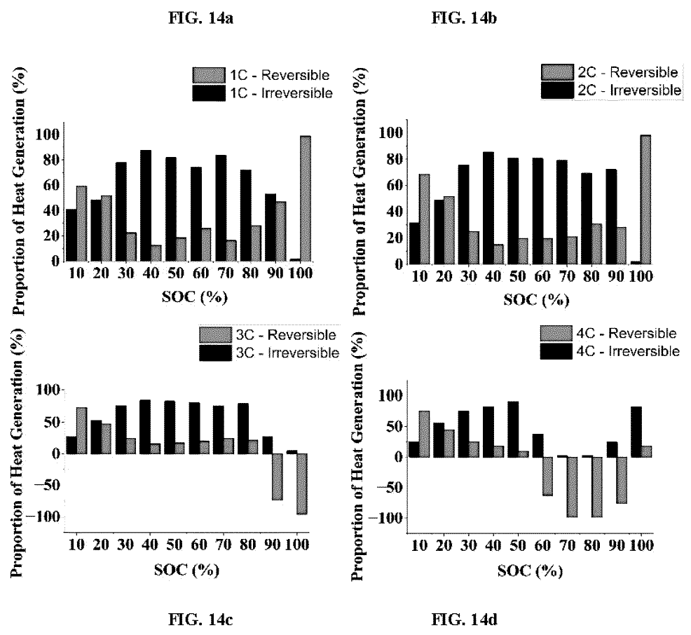

At 25 degrees Celsius, during the CC stage work, irreversible heat begins to increase for all four different C-rates. It should be noted that up to 20% SOC, reversible heat accounts for the majority of total heat. During the charging process at 3C and 4C rates, the CV stage begins after reaching 80% and 50% SOC respectively, and it can be observed from FIGS. 14a-c (collectively FIG. 14), that the reversible heat portion shows absorption. From FIGS. 14, we can see that for 1C and 2C rate reversible heat plays an important role during CV stage but during this time instead of heat absorption, heat generate. From FIGS. 11a-d, it is evident that irreversible heat generation is the key contributor to total heat generation for discharge rates of 2C to 4C until 80% DOD, except for 1C-rate discharge. As discharge progresses, irreversible heat generation becomes dominant over reversible heat generation with an increase in DOD due to a decrease in voltage. This results in increase heat loss. Reversible heat is observed to absorb heat during the first 20% of 1C-rate discharge, but overall heat generation increases due to irreversible heat generation. It should be noted that a significant amount of heat loss occurs during discharge.

Based on the data presented in FIG. 16e, a higher C-rate during the initial 10% state of charge (SOC) results in higher HGR. However, as the charging progresses, HGR decreases. FIG. 16f demonstrates that the maximum heat is generated during the final 10% of discharge. This suggests that the initial 10% of lithium ion intercalation or the final 10% of lithium ion de-intercalation are significant factors in heat generation.

Ratio of Reversible and Irreversible Heat at 15 Minutes after 0 Degree Celsius

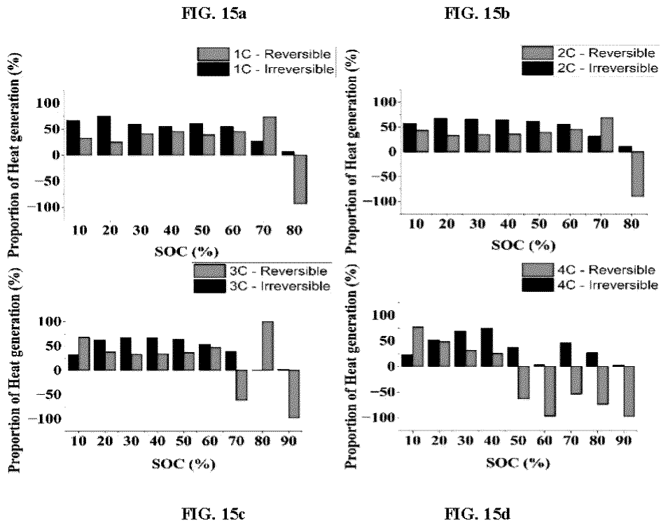

In FIGS. 15a-c, the heat generated from irreversible and reversible sources during charging is presented under specific thermal conditions 15 minutes after reaching 0 degrees Celsius. The maximum achievable SOC is 80% for 1C and 2C rates, with the CC stage stopping at 70% SOC. During this period, up to 60% of the maximum heat generated is due to irreversible heat, with reversible heat playing a vital role after that point. At 80% SOC, reversible heat absorbs the maximum amount of heat. For 3C and 4C rate charging, the heat is mainly absorbed by reversible sources during the constant voltage (CV) stage. The heat absorption rate is low during this stage, similar to other stages.

Based on the data presented in FIGS. 12a-d, it is apparent that irreversible heat generation is the main factor contributing to total heat generation when discharge rates range from 1C to 4C, until 80% DOD. As the discharge continues, irreversible heat generation becomes even more dominant over reversible heat generation, as the DOD increases and voltage decreases, resulting in increase heat loss. Although reversible heat does absorb heat at a 1C discharge rate and 30% DOD, overall heat generation increases due to irreversible heat generation. During discharge, it's important to note that a significant amount of heat is lost.

During the charging process, a unique characteristic can be observed 15 minutes after reaching 0 degrees Celsius. When the battery is charged at 0 degrees Celsius, it can be fully charged using the CV stage. During 15 minutes after 0-degree Celsius charging, FIG. 16c shows that when charging at rates of 1C-4C, the battery cannot achieve a full charge. This may be due to temperature differences causing the battery potential to behave differently and voltage to drop rapidly, reaching the lower cut-off voltage. FIG. 16d shows that the HGR is higher after 70% DOD. As entropy is dependent on temperature and open circuit voltage, a significant change can be observed, resulting in a large amount of heat generated compared to other conditions, which is reversible.

During the constant current process, the overpotential initially decreases, followed by a stable period with a slight rise, while the constant voltage process sees a gradual decrease in overpotential. The discharge process mirrors the symmetrical trend observed during the constant current process. The evolution of ohmic heat follows a similar pattern as polarization for different rates, where the degree of separation between the ohmic heat curves for charge and discharge increases with the rate. Heat generation is dominated by the lithium intercalation process.

### SUMMARY

Temperature distribution was evaluated and compared between the charge and discharge processes, followed by an analysis of heat generation rate and contribution. The conclusions drawn from this study are as follows: Firstly, during the constant current charge process, the duration is shorter for 15 minutes after 0 degree Celsius and never got full charge, the peak temperature is higher and nearly same as 25 degree Celsius, and the temperature rise rate is quicker compared to the corresponding discharge process. Secondly, during the charging process, for all condition the overall heat initially rises rapidly, then maintains a steady level for a prolonged period, and finally drops rapidly at the start of constant voltage charging. The overall heat experiences a decrease before the constant current charge cutoff, which can be attributed to the highest temperature during the charge not occurring precisely at the end of constant current charge. In contrast to the charge process, the overall heat exhibits an opposite and almost symmetrical trend during the discharge process, remaining low and then rising quickly towards the end of discharge. Thirdly, the constant current charge ends at a lower SOC, and more capacity is charged during the constant voltage charge process at a higher C-rate, but still presents a temperature growth. In terms of battery thermal management, controlling irreversible heat generation is crucial as it is the primary source of heat that needs to be regulated. Although some SOCs may show reversible heat generation as heat absorption, it can only offset a small portion of the heat released by irreversible heat generation. Additionally, reversible heat generation is influenced by the electrode material, which is difficult to regulate. Therefore, prioritizing the management of irreversible heat generation in the design of fast charging algorithm is essential. By minimizing the overpotential of the battery, the heat generation of the battery can be significantly reduced, which enhances the thermal safety of the battery.

### Optimization of Pulse Charging Algorithm to Attain Fast Charging of Lithium Ion Batteries in Subzero Temperature

At freezing temperatures, fast charging of a lithium-ion battery is extremely difficult due to insufficient ion transport through the electrolyte. In this research, a multi-stage charging protocol is proposed and subsequently optimized using numerical simulation to improve the uniformity of lithium-ion distribution while fast charging at freezing temperature (−15° C.). In the first stage of charging, a pulse charge followed by a pulse discharge steps are applied. In the second stage, a constant current (CC) charging process is integrated; and finally, a constant voltage (CV) charging is applied to the battery. A pulse charging protocol periodically changes the charging current direction which facilitates to increase the cell temperature and subsequently expedites ion transport in the electrolyte. To prevent over-discharging of the battery a capacity protection ratio is maintained in the first stage. The simulation results show that the higher pulse discharge (8C) with a low capacity protection ratio considerably reduces the total charging time. This study demonstrates multi-stage charging method is a viable approach to attain fast charging of a lithium-ion battery in subzero temperatures.

Lithium-ion batteries (LIBs) have become integral to modern life, powering a wide range of devices from portable electronics like laptops and smartphones to large-scale applications such as electric vehicles (EVs). Their energy density, reliability, and rechargeability make them the technology of choice in these applications. However, the charging performance of LIBs, like other battery chemistries, is subject to environmental factors, particularly at subzero temperatures [1]. Charging lithium-ion batteries at subzero temperatures can be challenging due to the increased risk of lithium plating and performance degradation. Due to these problems, the charging current in a freezing temperature environment must be maintained at a very low rate to charge the cell for a longer duration. Fast charging of a battery in freezing temperatures can exhibit high safety risks. To achieve fast charging of battery it is necessary to optimize the charging current, and as well as the charging time.

Preheating can be helpful when charging a battery at low temperature. This process ensures the battery operates within an optimal temperature range, enhancing safety and efficiency. Two widely accepted approaches for battery preheating are internal and external heating. Internal heating involves utilizing the battery's electrochemical reactions or resistive heating to raise its temperature. By contrast, external heating uses external sources, such as heaters or thermal chambers, to warm the battery. Both methods have their advantages and are chosen based on factors like energy efficiency, implementation complexity, and specific application requirements. Internal preheating of batteries can be achieved through methods such as self-heating and current excitation techniques. Self-heating leverages the battery's internal resistance to generate heat, while current excitation involves applying an alternating or pulsed current to warm the battery. The pulse preheating process applies a high current excitation over a short duration. This method is advantageous as it quickly generates significant heat, reduces impedance, and minimizes battery capacity loss.

Pulse charging techniques are widely applied to investigate cell performance at subzero temperatures. To charge the battery these technique utilizes periodically changing currents. Fast charging of a lithium-ion battery in the cold environment the pulse charging technique can be used to preheat the battery. The application of this process for battery charging is relatively complex, and very few research articles asserted that pulse charging may reduce the battery cycle life. However, recent research shows that pulse charging has a positive impact on battery charging performance. The main principle of the pulse charging process is that it interrupts constant current and direction, hence increasing the battery performance by changing the current amplitude, rest time, and discharge for a while. This charging mechanism helps to reduce dendrites formation and stabilize the solid electrolyte interface layers. Unlike constant current charging, the pulse charging process takes a longer time to charge a battery due to this method integrated with the discharge steps as well.

Modeling lithium-ion batteries using the Doyle-Fuller-Newman (DFN) model provides a rigorous framework for analyzing the electrochemical and transport phenomena within the battery. The DFN model describes lithium-ion transport across the layered structure of the positive electrode, separator, and negative electrode, offering detailed insights into time-dependent polarization caused by internal resistances. This approach enables the quantification and optimization of charging-induced polarization, particularly at subzero temperatures. In previous studies, charging-induced cell polarizations were successfully quantified, and eventually steps were taken to reduce the cell polarizations. Recent research reveals, that the pulse charging process has a positive impact on reducing cell polarizations. The nexus of modeling and experimental investigation enabled the high charging performance of lithium-ion batteries at subzero temperatures. However, a detailed understanding of the pulse charging process is essential to control the cell polarization and improve battery charging performance.

Simulations were conducted to investigation the consequences of applying a pulse charging technique to preheat the battery starting at −15° C. until 5° C. of temperatures. To quantify the charging-induced polarization, preheat time, and total charging time were investigated using a pseudo 2-D electrochemical and thermal model. A pouch full cell made of using lithium cobalt oxide (LiCoO₂) cathode, polymer separator, and graphite anode is simulated using Python Battery Mathematical Modeling (PyBaMM) software. Integrating a pulse charging current (i.e., discharging) mechanism with the CCCV charging protocol may increase the total charging time. Hence, another purpose of this work is to determine optimal preheating time as well as the total charging time. During the preheating stage if the pulse discharge capacity is higher than the stored capacity the battery will cross the lower cut-off voltage. To maintain the boundary conditions capacity protection ratio is defined in the model. Additionally, pulse charge duration and amplitude were optimized to minimize the total charging time.

### Numerical Method

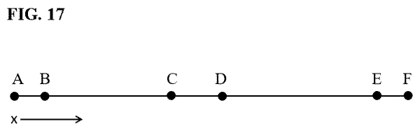

The electrochemical and thermal model is used according to Newman's battery model. The electrodes consist of solid active materials, conductive fillers, additive binders, and solution phases. According to the porous electrode theory, the various phases are assumed to be superimposed continua so that there is perfect connectivity between all points of the electrode in each phase. The electrode particles are treated as a spherical shape with a range of designated dimensions. To describe the lithium-ion intercalation/deintercalation in the particles Fick's second law is adopted in the model. The battery model consists of five domains as shown in FIG. 17; where AB is the negative current collector, BC is the negative electrode, CD is the polymer separator, DF is the positive electrode, and EF is the positive current collector.

The DFN model describes the concentration of electrolyte according to the following equation.

$$ε \frac{\partial {c}_{e}}{\partial t} = \frac{\partial }{\partial x} ( {D}_{e}^{eff} \frac{\partial {c}_{e}}{\partial x} ) + {aj}_{n} ( 1 - {t}_{+}^{0} ) , \qquad ( Equation 5 )$$

The effective diffusivity can be written as:

$${D}_{e}^{eff} = {D}_{e} \frac{ε}{τ} \qquad ( Equation 6 )$$

where cₑ is the concentration of lithium-ion in the liquid phase, ε is the electrode porosity, τ is the tortuosity,

$${t}_{+}^{0}$$

is the transference number of the lithium-ion in the liquid phase, a is the specific surface area, and jₙ is the pore wall flux of lithium-ion. Additionally, we assume that ε=1, and Jₙ=0 for the separator region, and the effective transport properties follow Bruggeman's porosity-tortuosity relation.

The potential in the liquid phase (41) is calculated using a lithium reference electrode:

$$\frac{\partial {φ}_{2}}{\partial x} = - \frac{{i}_{2}}{{k}_{eff}} + \frac{RT}{F} ( 1 - {t}_{+}^{0} ) ( 1 + \frac{\partial ln {f}_{2}}{\partial ln {c}_{e}} ) \frac{\partial ln {c}_{e}}{\partial x} , \qquad ( Equation 7 )$$

where the effective ionic conductivity (k_{eff}) of electrolyte in the porous medium is defined as k_{eff}=k (ε/τ), where k is the ionic conductivity, i₂ is the ionic current density is the electrolyte phase, and f₂ is the molar activity coefficient.

Now we can describe the porous electrode phase (solid) using Ohm's law,

$$I - {i}_{2} = - {σ}_{eff} \frac{\partial {φ}_{1}}{\partial x} \qquad ( Equation 8 )$$

where effective electronic conductivity,

$${σ}_{eff} = σ \frac{ε}{τ} ,$$

the ion insertion process of the lithium ions in the porous medium can be described by the Butler-Volmer kinetics equations:

$${J}_{n} = {J}_{0} ( exp ( \frac{{α}_{a} F}{RT} ( η - U ) ) - exp ( - \frac{{α}_{c} F}{RT} ( η - U ) ) ) \qquad ( Equation 9 )$$

Where αₐ, and α_{c} is the anodic, and cathodic charge transfer coefficient, respectively. The potential difference at the interface of solid and solution phase, η=φ₁−φ₂.

The exchange current density J₀ is defined as,

$${J}_{0} = {Fk}_{c}^{{α}_{a}} {{k}_{a}^{{α}_{c}} ( {c}_{s , max} - {c}_{s , surf} )}^{{α}_{a}} {( {c}_{s , surf} )}^{{α}_{c}} {( \frac{{c}_{e}}{{c}_{e , ref}} )}^{{α}_{a}} \qquad ( Equation 10 )$$

Where The concentration of lithium in the solid phase is determined by the local rate of insertion and Fick's second law:

$$\frac{\partial {c}_{s}}{\partial t} = {D}_{s} ( \frac{{\partial }^{2} {c}_{s}}{\partial {r}^{2}} + \frac{2}{r} \frac{\partial {c}_{s}}{\partial r} ) \qquad ( Equation 11 )$$

with boundary conditions,

$${J}_{n} = - {D}_{s} \frac{\partial {c}_{s}}{\partial r} at r = {R}_{s} , \qquad ( Equation 12 )$$

$$\frac{\partial {c}_{s}}{\partial r} = 0 at r = 0 \qquad ( Equation 13 )$$

$${c}_{s} ( t = 0 , r ) = {c}_{s , 0} , \qquad ( Equation 14 )$$

The definition of pore wall flux of lithium out of the solid phase into the solution phase can be written as:

$${aFj}_{n} = \frac{\partial {i}_{2}}{\partial x} \qquad ( Equation 15 )$$

Boundary conditions at the positive electrode/current collector boundary include:

$$\frac{\partial {c}_{e}}{\partial x} = 0 and {i}_{2} = 0 , \qquad ( Equation 16 )$$

The thermal model equations are based on energy conservation and describe the heat generation and dissipation process in the battery. In this study, a pouch cell thermal model is imported from the PyBaMM submodules. The heat generation accounts for the four sources, Ohmic heating (Q_{ohm,k}) due to electrolyte and electrode particles, reversible and irreversible heating due to entropic changes in the electrode (Q_{rev,k}), electrochemical reactions (Q_{rxn,k}), respectively; and heating due to contact resistance (Q_{cr}). The average heat source (Q̅) is calculated using volume average heat generation Q [44].

$$Q = {Q}_{Ohm , k} + {Q}_{rev , k} + {Q}_{r x n , k} + {Q}_{c r} , \qquad ( Equation 17 )$$

$$with ,$$

$${Q}_{Ohm , k} = - {i}_{k} ∇ {∅}_{k} , {Q}_{r e v , k} = {a}_{k} {j}_{k} {T}_{k} \frac{\partial U}{\partial T} {\vert}_{T = {T}_{∞}} , \qquad ( Equation 18 )$$

$${Q}_{r x n , k} = {a}_{k} {j}_{k} {η}_{k} , {Q}_{c r} = \frac{{R}_{c r}}{{V}_{c e l l}} {i}_{k}^{2}$$

Here, aₖ is the surface area to volume ratio, ηₖ is the overpotential, iₖ and Øₖ, is the current and potential, respectively. Also, U, V_{cell} and R_{cr} is the open-circuit voltage, total cell volume, and contact resistance.

The 1D model solves for T(x, t), taking differences through the thickness of the cell, where x represents the spatial coordinate through the thickness of the cell, and t represents time. The pouch cell model based on the heat equation can be expressed as:

$${ρ}_{k} {c}_{p , k} \frac{\partial T}{\partial t} = {λ}_{k} {∇}^{2} + Q ( x , t ) - {Q}_{cool} ( x , t ) \qquad ( Equation 19 )$$

with boundary condition for the negative electrode:

$$- {λ}_{c n} \frac{\partial T}{\partial x} = {h}_{c n} ( {T}_{∞} - T ) \qquad ( Equation 20 )$$

boundary condition for the positive electrode:

$$- {λ}_{cp} \frac{\partial T}{\partial x} = {h}_{cp} ( T - {T}_{∞} ) \qquad ( Equation 21 )$$

and initial condition:

$$T {\vert}_{t = 0} = {T}_{0} \qquad ( Equation 22 )$$

where λₖ is the thermal conductivity, h_{cn} and h_{cp} is the negative and positive current collector's heat transfer coefficients, respectively. T_{∞} is the ambient temperature, T₀ is the initial temperature.

### Design of Charging Protocol

To design a fast charging protocol using a pulse charging technique at subzero temperatures, the following issues must be considered: (a). Need to quantify pulse charging current's amplitude and duration, (b) Need to adjust pulse discharge current's amplitude and duration, (c) Need to decide at what cell temperature the periodical charge-discharge process will stop. In this study, we used a pulse charging technique to increase cell temperature from −15° C. to reach 5° C. During the pulse charging process to control the discharge a capacity protection ratio is defined for every pulse charging step [45]:

$$Capacity protection ratio = 1 - \frac{\int {I}_{discharge} dt}{\int {I}_{discharge} dt} \qquad ( Equation 23 )$$

A lower value of the capacity protection ratio means that the charging cycle is integrated with more discharge cycles. Similarly, a higher value of capacity retention ratio corresponds to a more pulse charging cycle. A higher capacity protection ratio may reduce total cell charging time but it would not facilitate to reduction of the lithium plating or dendrite formation. On the other hand, a lower capacity protection ratio may need a higher total charging time but it will help to increase cell temperature and reduce the lithium plating or dendrite formation. In essence, during the preheating process of a lithium-ion battery by applying a pulse charge-discharge mechanism the capacity protection ratio plays a vital role on the charging performance.

TABLE 2
Pulse charging protocol with a 4 C-rate discharge
current and 10% capacity protection ratio.

| | Charging | | Discharging | | Capacity |
|---|---|---|---|---|---|
| Cycle | current | Charging | current | Discharge | protection |
| No. | (C-rate) | time (s) | (C-rate) | time (s) | ratio (%) |
| 1 | 0.80 | 10 | 4 | 1.80 | 10 |
| 2 | 0.85 | 10 | 4 | 1.91 | 10 |
| 3 | 0.90 | 10 | 4 | 2.03 | 10 |
| 4 | 0.95 | 10 | 4 | 2.14 | 10 |
| 5 | 1.00 | 10 | 4 | 2.25 | 10 |
| 6 | 1.05 | 20 | 4 | 4.73 | 10 |
| 7 | 1.10 | 20 | 4 | 4.95 | 10 |
| 8 | 1.15 | 20 | 4 | 5.18 | 10 |
| 9 | 1.20 | 20 | 4 | 5.40 | 10 |
| 10 | 1.25 | 20 | 4 | 5.63 | 10 |
| 11 | 1.30 | 30 | 4 | 8.78 | 10 |
| 12 | 1.35 | 30 | 4 | 9.11 | 10 |
| 13 | 1.40 | 30 | 4 | 9.45 | 10 |
| 14 | 1.45 | 30 | 4 | 9.79 | 10 |
| 15 | 1.50 | 40 | 4 | 13.50 | 10 |
| 16 | 1.55 | 40 | 4 | 13.95 | 10 |
| 17 | 1.60 | 40 | 4 | 14.40 | 10 |
| 18 | 1.65 | 40 | 4 | 14.85 | 10 |
| 19 | 1.70 | 30 | 4 | 11.48 | 10 |

In Table 2, a group of pulse charging cycles are presented. The pulse charging current is gradually increases from 0.8C to 1.7C by an increment of 0.05C, where the pulse discharge current remains the same at 4C for all the cycles. In this case, the capacity protection ratio remains 10% of each cycle. The pulse charge-discharge process continues until the cell temperature reaches 5° C. Additionally, three more capacity protection ratios of 20%, 30%, and 40% were examined. It is assumed that the higher capacity proception ratio will reduce low heat generation of the cell; however, it may take lower charging time because it contains less amount of pulse discharge capacity. Furthermore, to investigate the influence of pulse discharge current on the internal heat generation at 6C and 8C of discharge currents was investigated.

The simulation study was divided into four phases:

In the first phase of the simulation, the charging performance of lithium-ion batteries was analyzed at two distinct temperatures to evaluate the effect of temperature on charging efficiency across varying C-rates. Simulations were conducted using conventional constant current (CC) charging protocols at 25° C. or 298.15 K (room temperature) and −15° C. or 258.15 K (subzero conditions).

In the second phase of the simulation, the pulse charging technique (discussed earlier) is used to preheat the battery at the ambient temperature of −15° C. (258.15 K). To investigate the charging performance at different capacity protection ratios and pulse discharge amplitude will be investigated.

In the third phase of simulation, a parametric study will be performed to examine the influence of pulse charging current, and pulse length. The pulse charging step is varied ±5% by keeping the same pulse length. On the other hand, the pulse charging length will be varied ±5% by keeping the same pulse current.

In the final phase of the simulation, the pulse charging current was progressively increased by a certain percentage from the baseline, reaching boundary conditions, to optimize the total charging time. Correspondingly, the charging time decreased incrementally as the pulse charging current increased, following the same stepwise progression of the percentage change.

### Results and Discussion

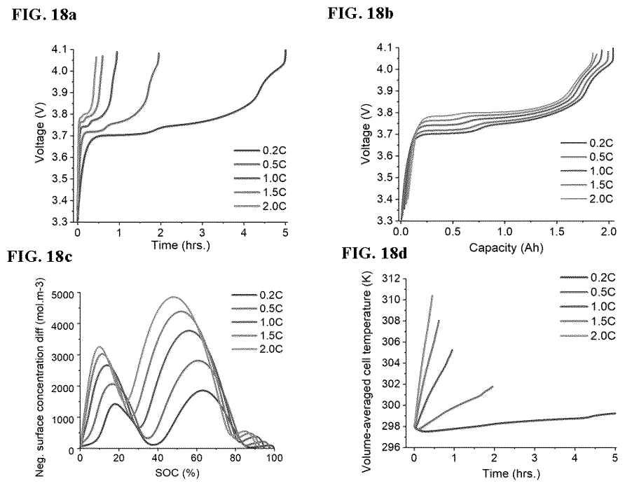

As shown in FIGS. 18a-18c, the charging performance of a LiCoO₂/graphite pouch cell at room temperature (298.15 K) was investigated. To understand the influences of constant charging current on the cell a series of C-rates (0.2, 0.5, 1, 1.5, and 2) were applied. FIG. 18a shows the voltage profile vs. time at different C-rates. At 0.2C rate of charging current, it took around 5 hrs. to reach 99% of SOC. On the other hand, at a 2C rate of charging current, it took around half an hour to reach around 91% of SOC. The voltage response for different c-rates complies with the total charging time.

FIG. 18b depicts voltage vs. capacity for different c-rates. As illustrated, when a low current was applied to the cell the voltage plateau was maintained at nearly 3.7 V; however, for the high charging current the voltage plateau is shifted near to 3.8 V. This plot shows that the operating voltage plateau of the cell was increased while increasing the charging currents. In FIG. 18c, the negative electrode surface concentration difference vs. state of charge (SOC) is presented. This lithium-ion concentration difference is quantified using a dynamic simulation process where the time-dependent lithium-ion concentration shows a periodic change of difference for different c-rates. At 0.2C rate of charging current, the lithium-ion concentration difference at 20% and 60% of SOC was higher. This implies that at an earlier stage of charging particles near the separator are intercalated at a higher rate than the current collector end. After 20% of SOC, the concentration difference was started to reduce and continued until 40% of SOC. A uniform lithium-ion concentration difference was observed at 40% of SOC. After 40% of SOC, the difference gradually increased to its maximum nearly at 60% of SOC. Finally, at the end of charging the concentration difference reached uniformity. Furthermore, while increasing the charging current the concentration difference appeared more evidently. For the 2.0C rate of charging current, around 10% of the initial concentration difference peak was observed. The difference reduced to its minimum nearly at 25% of SOC and afterward gradually increased to a maximum peak at 50% of SOC and subsequently the difference reached uniformity at 90% of SOC. A similar scenario was observed for the other c-rates as well. This investigation reveals how different c-rates influence the lithium-ion concentration difference in the negative electrode. In FIG. 18d, the volume-averaged cell temperature is presented for different c-rates. At 0.2C rate of charging current, it showed a very small temperature change. On the other hand, while applying higher c-rates of charging current very high heat generation was observed.

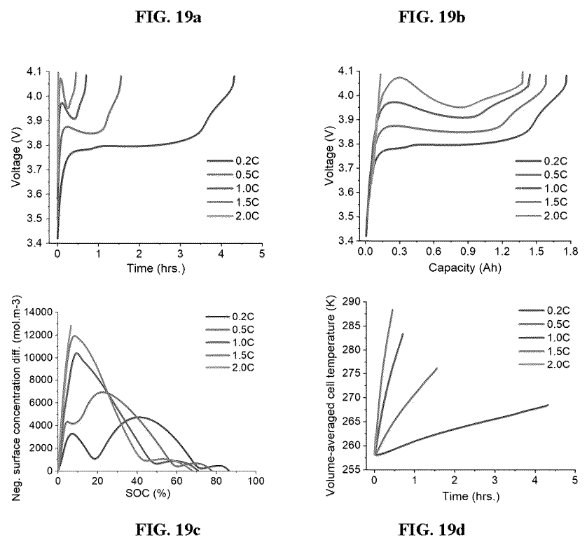

In FIGS. 19a-d, charging performance at −15° C. (258.15 K) is presented. At subzero temperatures, the diffusivity of lithium ions in the electrolyte drastically reduces. Due to this reason, the intercalation rate in the negative electrode substantially reduces. FIG. 19a shows the voltage profile vs. time at different c-rates. At 0.2C rate of charging current the cell took around 4.5 hrs. to reach around 86% of SOC. On the other hand, at a 2C rate of charging current the cell was not able to charge. Due to high voltage polarization in the negative electrode, the voltage reached to upper cut-off voltage and failed to continue charging. The voltage vs. charging capacity at different c-rates is shown in FIG. 19b Due to charging at a low temperature environment the charging capacity degraded when increasing the charging currents. At a low charging current (0.5C), the charging capacity went down to less than 80% of cell capacity. Additionally, a high voltage plateau was observed for each of the higher c-rates.

In FIG. 19c, the negative electrode surface concentration difference vs. SOC is presented. At 0.2C rate of charging current, a high initial concentration difference was observed around 10% of SOC. This difference was observed due to the low transport rate of lithium-ions in the electrolyte. When the charging current increased to 0.5C, the concentration difference was more evident. Near the 3% of SOC, a high spike of concentration difference was observed and this difference continued until SOC reached 60% of SOC. The charging voltage reached to maximum limit at 78% of SOC. At charging currents of 1C and 1.5C, a very high lithium-ion concentration difference was observed. This phenomenon describes that the high charging current only intercalated with the particles near the separator where lower diffusivity of the electrolyte hindered ion transport in the negative electrode. Similarly, when the 2C rate of charging current was applied, the cell polarization reached to upper cut-off limit of voltage. This implies that the lithium ions accumulate on the negative electrode surface and form dendrites and lithium plating. FIG. 19d shows the volume-averaged cell temperature vs. charging time. At 0.2C rate of charging current, the cell temperature slowly reached around 265 K which implies lower intercalation produces less heat in the cell. On the other hand, when 1C and 1.5C are applied to the cell fast temperature rise was observed. However, the 2C charging current reached cut-off voltage for that reason very small temperature change was noticed.

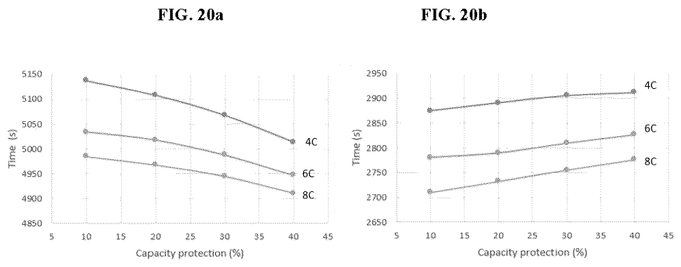

In the second phase of the simulation, we integrated the pulse charging technique to preheat the while charging the cell at 258.15 K. Our primary target preheats the cell until the cell temperature reaches 278.15 K and then integrates a higher charging current. FIG. 20a shows the cell charging time for different pulse discharge rates and capacity protection ratios. When the cell temperature reached 278.15 K then 1C CCCV charging was applied and calculated total charging time. This shows that at a 40% capacity protection ratio and 8C pulse discharge, the total charging time was nearly 4900 s. In FIG. 20b 2.5C CCCV was applied when the cell temperature reached 278.15 K. The simulation results show that the 10% capacity protection ratio with 8C pulse discharge performs better than other cases.

Any relative terms or terms of degree used herein, such as “substantially”, “essentially”, “generally”, “approximately” and the like, should be interpreted in accordance with and subject to any applicable definitions or limits expressly stated herein. In all instances, any relative terms or terms of degree used herein should be interpreted to broadly encompass any relevant disclosed embodiments as well as such ranges or variations as would be understood by a person of ordinary skill in the art in view of the entirety of the present disclosure, such as to encompass ordinary manufacturing tolerance variations, incidental alignment variations, alignment or shape variations induced by thermal, rotational or vibrational operational conditions, and the like.

While the invention is described with reference to thee provided exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of charging a lithium-ion battery, the method comprising:
sensing, via a temperature sensor, an environmental temperature;
performing an initial constant current charging and subsequent initial constant current discharge of the lithium-ion battery;
evaluating, by a processor, whether the sensed environmental temperature falls below a threshold temperature;
in response to the sensed environmental temperature being at or below a threshold temperature, performing dynamic alternating current (AC) charging according to a low-temperature charging algorithm to heat and charge the lithium-ion battery; and
in response to the sensed environmental temperature rising above the threshold temperature, switching from the low-temperature charging algorithm to a comparatively high-temperature charging algorithm for charging the lithium-ion battery.

2. The method of claim 1, wherein the temperature threshold is a 0° C.

3. The method of claim 1, wherein the low-temperature charging algorithm is a pulse charging algorithm.

4. The method of claim 3, wherein:
both the low-temperature and comparatively high-temperature charging algorithms are pulse charging algorithms, and
both the low-temperature charging algorithm and the comparatively high-temperature charging algorithm specify charging in a plurality of stages, each of the plurality of stages containing either:
a plurality of fixed current positive and negative charging pulses; or
a discharge pulse.

5. The method of claim 4, wherein the low-temperature charging algorithm specifies current amplitude for the positive charging pulses that is less than current for the positive charging pulses of the corresponding stages of the comparatively high-temperature charging algorithm.

6. The method of claim 5, wherein the comparatively high-temperature charging algorithm specifies current amplitude that is at least 1.5 times the current amplitude specified by the low-temperature charging algorithm for corresponding stages.

7. The method of claim 6, wherein the low-temperature charging algorithm and the comparatively high-temperature charging algorithm differ only in positive charging current amplitudes.

8. The method of claim 1, wherein all positive charging pulses of the low-temperature charging algorithm and the comparatively high-temperature charging algorithm have a first duration, and all negative charging pulses of the low-temperature charging algorithm and the comparatively high-temperature charging algorithm have a second duration much less than the first duration multiple orders of magnitude.

9. A lithium-ion battery (LIB) charging system, the system comprising:
a constant current source;
a pulse width modulation (PWM) controller;
a logic-capable processor; and
a temperature sensor,
wherein the logic-capable processor is configured to control charging of the LIB by:
receiving a sensed temperature from the temperature sensor;
ascertaining whether the sensed temperature is above freezing;
performing an initial constant-current charging and subsequent initial constant-current discharge of the LIB;
in response to determining that the sensed temperature is not above freezing, controlling charging of the LIB via the PWM controller according to a freezing-temperature pulse charging algorithm selected to heat and charge the LIB.

10. The LIB charging system of claim 9, wherein the logic-capable processor is further configured, in response to ascertaining that the sensed temperature has risen above freezing, to control charging of the LIB via the PWM controller according to an above-freezing-temperature pulse charging algorithm specifying higher current charging pulses than the freezing-temperature pulse charging algorithm.

11. The LIB charging system of claim 9, wherein the freezing-temperature pulse charging algorithm and the above-freezing pulse-charging algorithm differ only in current amplitude of positive charging pulses in charging stages, with adjacent charging stages separated by discharge stages.
